(19) United States
(12) Patent Application Publication
(10) Pub. No.: US 2023/0001451 A1
(43) Pub. Date: Jan. 5, 2023

(54) VIBRATION STRUCTURE, VIBRATION DEVICE, AND TACTILE SENSE PRESENTATION DEVICE

(71) Applicant: Murata Manufacturing Co., Ltd., Nagaokakyo-shi (JP)

(72) Inventor: Junichi HASHIMOTO, Nagaokakyo-shi (JP)

(21) Appl. No.: 17/942,610

(22) Filed: Sep. 12, 2022

Related U.S. Application Data
(63) Continuation of application No. PCT/JP2021/016537, filed on Apr. 22, 2021.

(30) Foreign Application Priority Data
Apr. 30, 2020 (JP) 2020-080401

(51) Int. Cl. B06B 1/06; G06F 3/041; G06F 3/01

(52) U.S. Cl. CPC B06B 1/06; G06F 3/041; G06F 3/016

(57) ABSTRACT

A vibration structure is provided that includes a vibration member including a frame having a first opening, a vibrator disposed inside the first opening and having a second opening, and one or more supports that support the vibrator to the frame; and a piezoelectric member disposed inside the second opening and having a first end and a second end, and expanding and contracting in a first direction connecting the first end and the second end when voltage is applied. Moreover, a first part and a second part of a first connection member are provided that connect the first end of the piezoelectric member to the frame; and a first part and a second part of a second connection member are provided that connect the second end of the piezoelectric member to the vibrator. At least the first connection member is an elastic body.

### CROSS REFERENCE TO RELATED APPLICATIONS

This application is a continuation of PCT Application No. PCT/JP2021/016357, filed Apr. 22, 2021, which claims priority to Japanese Patent Application No. 2020-080401, filed Apr. 30, 2020, the entire contents of each of which are hereby incorporated by reference in their entirety.

### TECHNICAL FIELD

The present invention relates to a vibration structure, a vibration device using the vibration structure, and a tactile presentation device using the vibration device.

### BACKGROUND ART

A touchscreen, which is an input device that operates equipment by a user pressing display on a screen, may include a tactile presentation device that, by transmitting vibration when the user presses the touchscreen, gives the user a tactile sense of pressing the touchscreen. Examples of vibration structure for generating vibration in a tactile presentation device include a vibration structure described in International Publication No. 2019/013164 (hereinafter “Patent Document 1”).

The vibration structure described in Patent Document 1 includes a film (hereinafter, referred to as “piezoelectric member”) that deforms in a planar direction in response to voltage application, a vibration member including a frame part, a vibration part, and a support part, and a connection member. In the vibration member, the frame part has an opening, and a part of a piezoelectric member is connected. The vibration part is disposed inside the opening, another part of the piezoelectric member is connected to the vibration part, and the piezoelectric member deforms in the planar direction to vibrate in the planar direction. The support part supports the vibration part to the frame part. The connection member connects the piezoelectric member and the frame part, and connects the piezoelectric member and the vibration part.

In the vibration structure described in Patent Document 1, a part of the piezoelectric member and the frame part are connected so as to overlap each other. That is, when a tactile presentation device incorporated with the vibration structure receives impact, tensile stress is likely to be generated in the piezoelectric member due to the impact. Therefore, there is a possibility that the piezoelectric member is damaged, and the tactile presentation device will not operate normally. In particular, when a piezoelectric ceramic, which is likely to be damaged by impact, is used as a piezoelectric member, or when a resin piezoelectric film is used but fixed in a state where tensile stress is intrinsic, and the piezoelectric member is liable to be damaged by generation of the tensile stress due to impact, this problem becomes remarkable.

### SUMMARY OF THE INVENTION

Accordingly, it is an object of the present invention to provide a vibration structure configured to suppress damage of a piezoelectric member when receiving impact, and a vibration device and a tactile presentation device using the vibration structure.

In an exemplary aspect, a vibration structure is provided that includes a vibration member including a frame, a vibrator, and a support, a piezoelectric member, a first connection member, and a second connection member. The frame has a first opening. The vibrator is disposed inside the first opening and has a second opening. The support supports the vibrator to the frame. The piezoelectric member is disposed inside the second opening, has a first end and a second end, and expands and contracts in a first direction connecting the first end and the second end when voltage is applied. The first connection member connects the first end of the piezoelectric member and the frame. The second connection member connects the second end of the piezoelectric member and the vibrator. At least the first connection member is an elastic body.

In another exemplary aspect, a vibration device is provided that includes the vibration structure described herein and a drive circuit configured to apply voltage to the piezoelectric member included in the vibration structure.

Furthermore, in an exemplary aspect, a tactile presentation device is provided that includes the vibration device described herein and a pressure detector that detects pressure on the vibrator included in the vibration structure.

The vibration structure according to the present invention can, by elastic deformation of the first connection member, which is an elastic body, suppress the generation of tensile stress in the piezoelectric member when receiving impact. Therefore, damage of the piezoelectric member can also be prevented when receiving impact. Since the vibration device disclosed herein uses the vibration structure, failure can also be suppressed when receiving impact. Furthermore, since the tactile presentation device uses the vibration device as disclosed herein, the user can be provided a tactile sense also after receiving impact. When this device is used as a device for removing and conveying a droplet, powder, and the like, it is similarly possible to maintain its function after receiving impact.

### BRIEF DESCRIPTION EXPLANATION OF DRAWINGS

FIG. 1(A) is a perspective view of a vibration structure 100, which is a schematic form of the vibration structure according to an exemplary embodiment. FIG. 1(B) is a partial sectional view of the vibration structure 100 taken along a plane including line X1-X1 illustrated in FIG. 1(A), and illustrates connection between a piezoelectric member 2 and a first connection member 3 and connection between a voltage application member 5 and the first connection member 3.

FIG. 2(A) is a plan view of the vibration structure 100 in a state before receiving impact. FIG. 2(B) is a plan view of the vibration structure 100 in a state of receiving impact along a first direction D1 so that a vibration part 1b is displaced in an orientation from a first part 3a of the first connection member 3 toward a first part 4a of the second connection member 4. FIG. 2(C) is a plan view of the vibration structure 100 in a state of receiving impact along a first direction D1 so that a vibration part 1b is displaced in an orientation from the first part 4a of the second connection member 4 toward the first part 3a of the first connection member 3.

FIG. 3 is a perspective view of a vibration structure 100A, which is a first modification of the vibration structure 100.

FIG. 4 is a perspective view of a vibration structure 100B, which is a second modification of the vibration structure 100.

FIG. 5(A) is a perspective view of a vibration structure 100C, which is a third modification of the vibration structure 100. FIG. 5(B) is a perspective view illustrating that a bent part provided in a coupling part 3a3 of the first part 3a of the first connection member 3 contracts due to the impact received along the first direction D1 by the vibration structure 100C.

FIG. 6(A) is a perspective view of a vibration structure 100D, which is a fourth modification of the vibration structure 100. FIG. 6(B) is a perspective view illustrating that a second plate-shaped part 3a2 of the first part 3a of the first connection member 3 sags in the first direction D1 due to the impact received along the first direction D1 by the vibration structure 100D.

FIG. 7 is a perspective view of a vibration structure 100E, which is a fifth modification of the vibration structure 100.

FIG. 8 is a perspective view of a vibration structure 100F, which is a sixth modification of the vibration structure 100.

FIG. 9(A) is a perspective view of a vibration structure 100G, which is a seventh modification of the vibration structure 100. FIG. 9(B) is a plan view illustrating expansion and contraction of the bent part of each support part, expansion and contraction of the bent part of the second plate-shaped part 3a2 of each connection member, and deformation of the first part 3a of the first connection member 3 due to the impact received along the second direction D2 by the vibration structure 100G.

FIG. 10 is a perspective view of a vibration structure 100H, which is an eighth modification of the vibration structure 100.

FIG. 11(A) is a perspective view of a vibration structure 100I, which is a ninth modification of the vibration structure 100. FIG. 11(B) is a sectional view of the vibration structure 100I taken along a plane including line X2-X2 illustrated in FIG. 11(A), as viewed in the direction of arrows.

FIG. 12 is a perspective view of a vibration structure 100J, which is a tenth modification of the vibration structure 100.

FIG. 13 is an exploded perspective view of the vibration structure 100J.

FIG. 14 is a perspective view of a vibration structure 100K, which is an eleventh modification of the vibration structure 100.

FIG. 15 is an exploded perspective view of the vibration structure 100K.

FIG. 16 is a perspective view of a vibration structure 100L, which is a twelfth modification of the vibration structure 100.

FIG. 17 is an exploded perspective view of the vibration structure 100L.

FIG. 18 is a perspective view of a vibration structure 100M, which is a thirteenth modification of the vibration structure 100.

FIG. 19 is an exploded perspective view of the vibration structure 100M.

FIG. 20 is a perspective view of a vibration structure 100N, which is a fourteenth modification of the vibration structure 100.

FIG. 21 is a perspective view of a vibration structure 100P, which is a fifteenth modification of the vibration structure 100.

FIG. 22 is a perspective view of a vibration device 1000, which is a schematic form of the vibration device.

FIG. 23 is a perspective view of a tactile presentation device 2000, which is a schematic form of the tactile presentation device.

FIG. 24 is an exploded perspective view of the tactile presentation device 2000.

FIG. 25 is a perspective view of a vibration structure 100D-2, which is a fourth-2 modification of the vibration structure 100.

FIG. 26 is a perspective view illustrating that the second plate-shaped part 3a2 of the first part 3a of the first connection member 3 sags in the first direction D1 due to the impact received along the first direction D1 by the vibration structure 100D-2, which is the fourth-2 modification of the vibration structure 100.

### DETAILED DESCRIPTION

Features of the present disclosure will be described with reference to the drawings and the exemplary embodiments. In the following schematic forms and embodiments of a linear vibration motor, identical or common parts are denoted by identical reference symbols in the drawings, and the description thereof is sometimes not repeated.

Schematic Form of Vibration Structure—

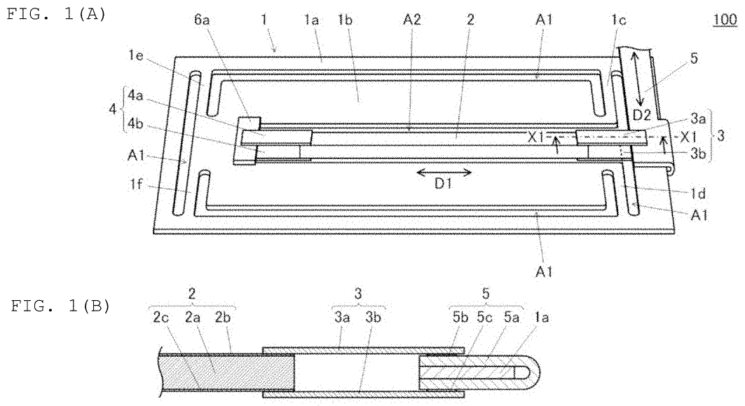

The vibration structure 100, which is a schematic form of the vibration structure according to an exemplary embodiment, will be described with reference to FIGS. 1(A)-(B) and 2(A)-(B). FIG. 1(A) is a perspective view of the vibration structure 100. FIG. 1(B) is a partial sectional view of the vibration structure 100 taken along a plane including line X1-X1 illustrated in FIG. 1(A), and illustrates connection between a piezoelectric member 2 and a first connection member 3 and connection between a voltage application member 5 and the first connection member 3.

As illustrated, the vibration structure 100 includes a vibration member 1, the piezoelectric member 2, the first connection member 3, and the second connection member 4. The first connection member 3 includes the first part 3a and a second part 3b. The second connection member 4 includes the first part 4a and a second part 4b. The vibration member 1 includes a frame part 1a (or simply a “frame”), the vibration part 1b (or simply a “vibrator”), and support parts 1c to 1f (or simply “supports”). The vibration structure 100 is connected to a circuit or a device that applies voltage to the piezoelectric member 2, such as a drive circuit 200 (not illustrated in FIG. 1(A)) described later, with the voltage application member 5 interposed therebetween.

As shown, the vibration member 1 has a first main surface and a second main surface facing back-to-back the first main surface. The frame part 1a of the vibration member 1 has a first opening A1. The vibration part 1b is a plate-shaped member having a rectangular main part and having protrusions on opposing short sides, and is disposed inside the first opening A1. The vibration part 1b is formed with a rectangular second opening A2 having a long axis along an expansion and contraction direction of the piezoelectric member 2 described later in a plan view. The second opening A2 is in communication with the first opening A1. The support parts 1c to 1f each have a strip shape extending in a direction (second direction D2 described later) orthogonal to the expansion and contraction direction of the piezoelectric member 2 described below, and each supports the vibration part 1b to the frame part 1a by connecting the frame part 1a and the protrusion of the vibration part 1b.

In the vibration structure 100, the frame part 1a, the vibration part 1b, and the support parts 1c to 1f of the vibration member 1 are formed of the identical member. As a material of the vibration member 1, a fiber-reinforced plastic material can be used, for example, such as an acrylic resin, polyethylene terephthalate, polycarbonate, or a glass epoxy composite material, metal, glass, or the like. In a case where metal is used, stainless steel, a tungsten alloy, a titanium alloy, or the like is preferable. A board material for circuit wiring may also be used. In this case, the part related to the electric wiring can be simplified.

That is, the frame part 1a, the vibration part 1b, and the support parts 1c to 1f can be formed by punching one rectangular plate member such that these sites remain. In this case, the frame part 1a, the vibration part 1b, and the support parts 1c to 1f can be easily formed. Furthermore, when punching is performed with the identical member, it is easy to match the natural vibration periods of the plurality of support parts 1c to 1f. Therefore, vibration variation can be reduced when the vibration part 1b is vibrated.

However, in the exemplary aspects of the present disclosure, the frame part 1a, the vibration part 1b, and the support parts 1c to 1f do not need to be formed of the identical member, and may be different members. For example, when the plurality of support parts 1c to 1f are of different members, the vibration state of the vibration part 1b can be adjusted by changing the material of each support part from the material of the frame part 1a and the vibration part 1b. For example, use of a material, such as rubber, for the support parts 1c to 1f facilitates an increase of the vibration of the vibration part 1b while reducing the voltage applied to the piezoelectric member 2.

Moreover, the piezoelectric member 2 includes a piezoelectric element 2a having a prismatic shape, a first electrode 2b provided on a first main surface of the piezoelectric element 2a, and a second electrode 2c on a second main surface facing back-to-back to the first main surface, and has a first end and a second end (see FIG. 1(B)). The piezoelectric member 2 is disposed inside the second opening A2, and expands and contracts in a first direction D1 connecting the first end and the second end when voltage is applied between the electrodes. As mentioned earlier, the first direction D1, which is the expansion and contraction direction of the piezoelectric member 2, is parallel to the long axis of the rectangular second opening A2. As a material of the piezoelectric element 2a, a piezoelectric ceramic material can be used that exhibits a large inverse piezoelectric effect, for example, such as lead zirconate titanate and lead-free piezoelectric ceramics such as niobium piezoelectric ceramics. In this case, the vibration of the vibration part 1b can be increased.

The voltage is applied between the electrodes of the piezoelectric member 2 in the vibration structure 100 from the voltage application member 5 described later with the first part 3a and the second part 3b of the first connection member 3 interposed therebetween. However, the voltage may be applied from the voltage application member 5 not by the first part 3a and the second part 3b of the first connection member 3 but another wiring interposed therebetween. The voltage may be applied not by the voltage application member 5, but another wiring and the first part 3a and the second part 3b of the first connection member 3 interposed therebetween. Furthermore, the voltage may be applied not by the voltage application member 5 and the first part 3a and the second part 3b of the first connection member 3, but another wiring interposed therebetween.

However, it is noted that in the exemplary aspects of the present disclosure, the piezoelectric element 2a does not need to have a prismatic shape, and may have a columnar shape other than a prismatic shape, such as a cylindrical shape, or may have a plate shape or a film shape. For example, when the piezoelectric element 2a has a plate shape or a film shape, a resin piezoelectric film, such as polyvinylidene fluoride, poly-L-lactic acid, and poly-D-lactic acid can be used as a material of the piezoelectric element 2a. When the piezoelectric member 2 is the resin piezoelectric film as described above, it is preferably connected to each connection member described later in a state where tensile stress is intrinsic, that is, in a state where tension is applied. However, it is not essential that the tensile stress is intrinsic in the resin piezoelectric film, and it may be connected to each connection member so that the tensile stress is generated only when the resin piezoelectric film contracts.

As further illustrated, the piezoelectric member 2 is connected to the frame part 1a of the vibration member 1 by the first part 3a and the second part 3b of the first connection member 3, and is connected to the vibration part 1b of the vibration member 1 by the first part 4a and the second part 4b of the second connection member 4. Each part of the first connection member 3 and the second connection member 4 has a strip shape extending along the first direction D1, which is the expansion and contraction direction of the piezoelectric member 2.

The first part 3a of the first connection member 3 is an elastic body, and connects the first end of the first electrode 2b provided on the first main surface of the piezoelectric member 2 and the first main surface of the frame part 1a with the voltage application member 5 interposed therebetween. As mentioned earlier, the first part 3a of the first connection member 3 can be a voltage supply path to the piezoelectric member 2.

The second part 3b of the first connection member 3 and the first part 4a and the second part 4b of the second connection member 4 are also elastic bodies similar to the first part 3a of the first connection member 3. The second part 3b of the first connection member 3 connects the first end of the second electrode 2c provided on the second main surface of the piezoelectric member 2 and the second main surface of the frame part 1a while facing the first part 3a of the first connection member 3 with the voltage application member 5 interposed therebetween. The second part 3b of the first connection member 3 can also be a voltage supply path to the piezoelectric member 2.

The first part 4a of the second connection member 4 connects the second end of the first electrode 2b provided on the first main surface of the piezoelectric member 2 and the first main surface of the vibration part 1b with a fixing member 6a interposed therebetween. The second part 4b of the second connection member 4 connects the second end of the second electrode 2c provided on the second main surface of the piezoelectric member 2 and the second main surface of the vibration part 1b while facing the first part 4a of the second connection member 4 with a fixing member 6b not illustrated interposed therebetween. In another exemplary aspect, the first part 4a of the second connection member 4 may connect the second end of the first electrode 2b and the vibration part 1b without the fixing member 6a interposed therebetween. Moreover, the second part 4b of the second connection member 4 may connect the second end of the second electrode 2c and the vibration part 1b without the fixing member 6b interposed therebetween.

As a material of the first connection member 3 and the second connection member 4, a copolymer synthetic resin can be used, for example, of acrylonitrile, butadiene, and styrene, polyethylene terephthalate, polycarbonate, polyimide, polyamideimide, metal, or the like. In a case of focusing on the material, it is possible to select, from them, one having a Young's modulus smaller than that of the vibration member 1 or the piezoelectric member 2. However, as described later, the first connection member 3 and the second connection member 4 can function as elastic bodies due to their structures even when the Young's modulus is larger than that of the vibration member 1 or the piezoelectric member 2. Therefore, the magnitude relationship of the Young's modulus is not an essential condition in the exemplary aspect. When the first part 3a and the second part 3b of the first connection member 3 are voltage supply paths to the piezoelectric member 2, a wiring material such as copper is further included in addition to the above. As the elastic body, a stretchable material may be used, or a stretchable structural member such as a spring may be used.

In the exemplary aspect, the voltage application member 5 is an L-shaped flexible cable having a first main surface and a second main surface, and having a part extending along the second direction D2 orthogonal to the first direction D1 and a part extending along the first direction D1 in a plan view. The voltage application member 5 includes a cable body 5a, a first electrode 5b provided in a part extending along the second direction D2 on the first main surface side of the cable body 5a, and a second electrode 5c provided in a part extending along the first direction D1 on the first main surface side.

The first electrode 5b of the voltage application member 5 is connected to the wiring of the first part 3a of the first connection member 3. By the part extending along the first direction D1 being bent, the second electrode 5c of the voltage application member 5 is connected to the wiring of the second part 3b of the first connection member 3 opposing the first part 3a of the first connection member 3 with the frame part 1a interposed therebetween. However, as mentioned earlier, the voltage may be applied between the electrodes of the piezoelectric member 2 from the voltage application member 5 with another wiring interposed therebetween without the first part 3a and the second part 3b of the first connection member 3 interposed therebetween.

In addition, the fixing member 6a that fixes the first part 4a of the second connection member 4 and the vibration part 1b and the fixing member 6b not illustrated that fixes the second part 4b of the second connection member 4 and the vibration part 1b have strip shapes extending along the second direction D2 in the plan view. As a material of each fixing member, a material such as metal, polyethylene terephthalate, polycarbonate, polyimide, polyamideimide, or a copolymer synthetic resin of acrylonitrile, butadiene, and styrene, can be used, for example. When each fixing member itself has adhesiveness, each fixing member and each constituent member are directly adhered. When each fixing member itself does not have adhesiveness, they may be bonded with an adhesive or the like.

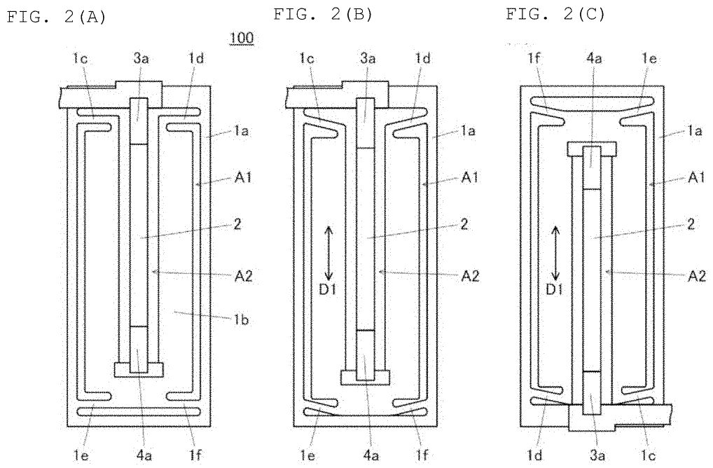

FIG. 2(A) is a plan view of the vibration structure 100 in a state before receiving impact. FIG. 2(B) is a plan view of the vibration structure 100 in a state of receiving impact along a first direction D1 so that a vibration part 1b is displaced in an orientation from a first part 3a of the first connection member 3 toward a first part 4a of the second connection member 4. FIG. 2(C) is a plan view of the vibration structure 100 in a state of receiving impact along a first direction D1 so that a vibration part 1b is displaced in an orientation from the first part 4a of the second connection member 4 toward the first part 3a of the first connection member 3.

It is assumed that the vibration structure 100 receives impact by which the state becomes from the state of FIG. 2(A) to the state of FIG. 2(B). In the exemplary embodiment, the piezoelectric member 2 is connected to the frame part 1a and the vibration part 1b with each connection member that is an elastic body interposed therebetween. Therefore, each connection member extends in the plan view from the initial state with respect to displacement of the vibration part 1b due to impact, so that a change in the relative positional relationship can be suppressed between the vibration member 1 and the piezoelectric member 2. That is, generation of tensile stress in the piezoelectric member 2 due to displacement of the vibration part 1b can be suppressed by elastic deformation of each connection member.

Next, it is assumed that the vibration structure 100 receives impact by which the state becomes from the state of FIG. 2(A) to the state of FIG. 2(C). In this case, each connection member contracts in the plan view from the initial state with respect to displacement of the vibration part 1b due to impact, so that a change in the relative positional relationship between the vibration member 1 and the piezoelectric member 2 can be suppressed. That is, similarly to the case illustrated in FIG. 2(B), generation of tensile stress in the piezoelectric member 2 due to displacement of the vibration part 1b can be suppressed by elastic deformation of each connection member.

In the vibration structure 100, connection members are connected to the first end and the second end of the first main surface of the piezoelectric member 2 and the first end and the second end of the second main surface facing back-to-back to the first main surface. Therefore, the first main surface and the second main surface can balance the stress generated in each of the connected connection members. Therefore, when each connection member expands and contracts due to the impact received by the vibration structure 100, particularly when each connection member contracts as illustrated in FIG. 2(C), generation of force for sagging the piezoelectric member 2 in a normal direction of the vibration part 1b can also be suppressed. As a result, it is possible to suppress damage due to sagging of the piezoelectric member 2 particularly when a piezoelectric ceramic material is used as the material of the piezoelectric member 2.

As described above, by elastic deformation of each connection member that is an elastic body, the vibration structure 100 according to the exemplary aspect of the present disclosure can suppress generation of tensile stress in the piezoelectric member 2 when receiving impact. Therefore, damage of the piezoelectric member 2 can be prevented when receiving impact.

First Modification of Vibration Structure—

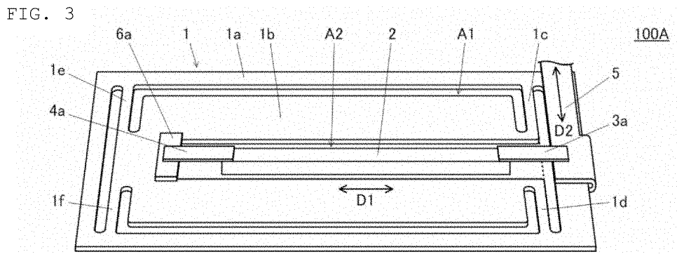

The first modification of the vibration structure 100, which is a schematic form of the vibration structure according to the present disclosure, will be described with reference to FIG. 3. FIG. 3 is a perspective view of the vibration structure 100A, which is a first modification of the vibration structure 100. The vibration structure 100A is different from the vibration structure 100 in the number of connection members (see FIG. 1). Since the other configurations are similar to those of the vibration structure 100, redundant description is omitted.

As illustrated in FIG. 3, the vibration structure 100A includes the first part 3a of the first connection member 3 and the first part 4a of the second connection member 4 as connection members. That is, the first end of the first electrode 2b of the piezoelectric member 2 is connected to the first main surface of the frame part 1a with the voltage application member 5 interposed therebetween by the first part 3a of the first connection member 3, and the second end of the first electrode 2b is connected to the first main surface of the vibration part 1b with the fixing member 6a interposed therebetween by the first part 4a of the second connection member 4. The voltage is applied to the piezoelectric member 2 in the vibration structure 100A from the voltage application member 5 with the first part 3a of the first connection member 3 connected to the first electrode 2b and another wiring connected to the second electrode 2c interposed therebetween. However, a voltage supply path other than this may be used in alternative aspects.

By elastic deformation of the first part 3a of the first connection member 3 and the first part 4a of the second connection member 4, which are elastic bodies, the vibration structure 100A can also suppress generation of tensile stress in the piezoelectric member 2 when receiving impact, similarly to that mentioned earlier. Therefore, damage of the piezoelectric member 2 can be prevented when receiving impact.

Second Modification of Vibration Structure—

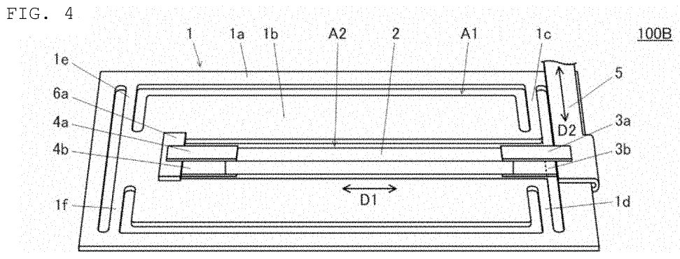

The second modification of the vibration structure 100, which is a schematic form of the vibration structure according to the present disclosure, will be described with reference to FIG. 4. FIG. 4 is a perspective view of the vibration structure 100B, which is the second modification of the vibration structure 100. The vibration structure 100B is different from the vibration structure 100 in the number of connection members and the form of the fixing member (see FIG. 1). Since the other configurations are similar to those of the vibration structure 100, redundant description is omitted.

As illustrated in FIG. 4, the vibration structure 100B has a similar structure to that of the vibration structure 100 (see FIG. 1(A)). However, in the vibration structure 100B, the first part 4a and the second part 4b of the second connection member 4 are not elastic bodies as the first part 3a and the second part 3b of the first connection member 3. That is, the first part 4a of the second connection member 4 is configured to function as a fixing member that fixes the second end of the first electrode 2b of the piezoelectric member 2 to the first main surface of the vibration part 1b with the fixing member 6a interposed therebetween. The second part 4b of the second connection member 4 is configured to function as a fixing member that fixes the second end of the second electrode 2c of the piezoelectric member 2 to the second main surface of the vibration part 1b with the fixing member 6b while interposed therebetween while opposing the first part 4a. However, the shapes of the first part 4a and the second part 4b of the second connection member 4 are not limited to this.

In an exemplary aspect, the fixing member 6a and the first part 4a of the second connection member 4 may be integrally molded. The fixing member 6b and the second part 4b of the second connection member 4 may be integrally molded. The first part 4a of the second connection member 4 may connect the second end of the first electrode 2b of the piezoelectric member 2 and the vibration part 1b without the fixing member 6a interposed therebetween. The second part 4b of the second connection member 4 may connect the second end of the second electrode 2c of the piezoelectric member 2 and the vibration part 1b without the fixing member 6b interposed therebetween.

The voltage is applied to the piezoelectric member 2 in the vibration structure 100B from the voltage application member 5 described later with the first part 3a and the second part 3b of the first connection member 3 interposed therebetween, similarly to the vibration structure 100. However, a voltage supply path other than this may be used in alternative aspects.

By elastic deformation of the first part 3a and the second part 3b of the first connection member 3, which are elastic bodies, the vibration structure 100B can also suppress generation of tensile stress in the piezoelectric member 2 when receiving impact, similarly to that mentioned earlier. Therefore, damage of the piezoelectric member 2 can be prevented when receiving impact.

In the vibration structure 100B, connection members are connected to the first end and the second end of the first main surface of the piezoelectric member 2 and the first end and the second end of the second main surface facing back-to-back to the first main surface. Therefore, the first main surface and the second main surface can balance the stress generated in each of the connected connection members. Therefore, when each connection member expands and contracts due to the impact received by the vibration structure 100B, particularly when the connection members contract, it is possible to suppress generation of force for sagging the piezoelectric member 2 in a normal direction of the vibration part 1b. As a result, damage due to sagging of the piezoelectric member 2 can be prevented particularly when a piezoelectric ceramic material is used as the material of the piezoelectric member 2.

Third Modification of Vibration Structure—

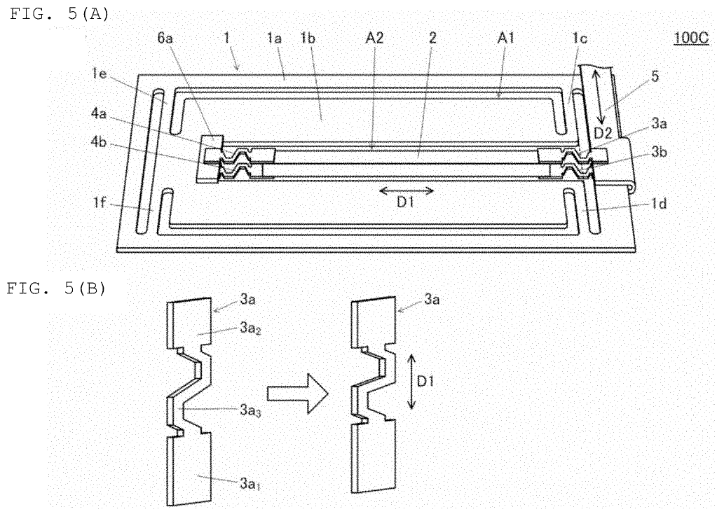

The third modification of the vibration structure 100, which is a schematic form of the vibration structure according to the present disclosure, will be described with reference to FIGS. 5(A) and 5(B). FIG. 5(A) is a perspective view of the vibration structure 100C, which is the third modification of the vibration structure 100. FIG. 5(B) is a perspective view illustrating that a bent part provided in a coupling part 3a3 of the first part 3a of the first connection member 3 contracts due to the impact received along the first direction D1 by the vibration structure 100C. The vibration structure 100C is different from the vibration structure 100 in the form of each connection member (see FIG. 1). Since the other configurations are similar to those of the vibration structure 100, redundant description is omitted.

As illustrated in FIG. 5(A), the vibration structure 100C also includes the first part 3a and the second part 3b of the first connection member 3 and the first part 4a and the second part 4b of the second connection member 4 as connection members. However, each connection member in the vibration structure 100C has a bent part. For example, as illustrated in FIG. 5(B), the first part 3a of the first connection member 3 includes a first plate-shaped part 3a₁ connected to the first end of the first electrode 2b of the piezoelectric member 2, the second plate-shaped part 3a₂ connected to the frame part 1a, and the coupling part 3a₃ coupling the first plate-shaped part 3a₁ and the second plate-shaped part 3a₂ along the first direction D1 and provided with a macroscopically wavy bent part. That is, the coupling part 3a₃ is a planar spring that enhances the stretchability of the first part 3a of the first connection member 3 along the first direction D1. In FIG. 5(B), the bent part has an angular wave shape, but is not limited to this configuration.

The second part 3b of the first connection member 3 and the first part 4a and the second part 4b of the second connection member 4 also have a structure similar to that of the first part 3a of the first connection member 3. That is, the second part 3b of the first connection member 3 and the bent parts of the first part 4a and the second part 4b of the second connection member 4 are also planar springs that enhance the stretchability of each connection member along the first direction D1.

The voltage is applied to the piezoelectric member 2 in the vibration structure 100C from the voltage application member 5 described later with the first part 3a and the second part 3b of the first connection member 3 interposed therebetween, similarly to the vibration structure 100. However, a voltage supply path other than this may be used.

By elastic deformation of the first part 3a and the second part 3b of the first connection member 3 and the first part 4a and the second part 4b of the second connection member 4, which are elastic bodies, the vibration structure 100C can also suppress generation of tensile stress in the piezoelectric member 2 when receiving impact, similarly to that mentioned earlier. Therefore, damage of the piezoelectric member 2 can be prevented when receiving impact. In particular, in the vibration structure 100C, the coupling part 3a₃ of each vibration member is provided with a bent part that is a planar spring as illustrated in FIG. 5(B). Therefore, each vibration member easily expands and contracts against impact. Therefore, damage of the piezoelectric member 2 when receiving impact can be prevented.

In the vibration structure 100C, connection members are connected to the first end and the second end of the first main surface of the piezoelectric member 2 and the first end and the second end of the second main surface facing back-to-back to the first main surface. Therefore, the first main surface and the second main surface can balance the stress generated in each of the connected connection members. Therefore, when each connection member expands and contracts due to the impact received by the vibration structure 100C, particularly when the connection members contract, it is possible to suppress generation of force for sagging the piezoelectric member 2 in a normal direction of the vibration part 1b. As a result, it is possible to suppress damage due to sagging of the piezoelectric member 2 particularly when a piezoelectric ceramic material is used as the material of the piezoelectric member 2.

Fourth Modification of Vibration Structure—

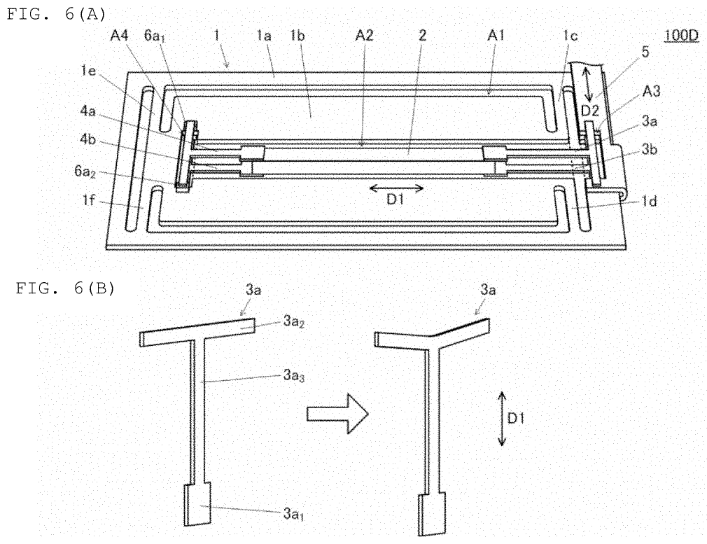

The fourth modification of the vibration structure 100, which is a schematic form of the vibration structure according to the present disclosure, will be described with reference to FIGS. 6(A) and 6(B). FIG. 6(A) is a perspective view of the vibration structure 100D, which is the fourth modification of the vibration structure 100. FIG. 6(B) is a perspective view illustrating that a second plate-shaped part 3a₂ of the first part 3a of the first connection member 3 sags in the first direction D1 due to the impact received along the first direction D1 by the vibration structure 100D. The vibration structure 100D is different from the vibration structure 100 in the frame part 1a, the vibration part 1b, and the form of each connection member (see FIG. 1). Since the other configurations are similar to those of the vibration structure 100, redundant description is omitted.

As illustrated in FIG. 6(A), the vibration structure 100D also includes the first part 3a and the second part 3b of the first connection member 3 and the first part 4a and the second part 4b of the second connection member 4 as connection members. However, as illustrated in FIG. 6(B), each connection member in the vibration structure 100D has a T-shape including the first plate-shaped part 3a₁ connected to the first end of the first electrode 2b of the piezoelectric member 2, the second plate-shaped part 3a₂ extending along the second direction D2 orthogonal to the first direction D1 and connected to the frame part 1a, and the coupling part 3a₃ coupling the first plate-shaped part 3a₁ and the second plate-shaped part 3a₂. The frame part 1a has a third opening A3. The voltage application member 5 also has an opening having a similar shape to that of the third opening A3 and communicating with the third opening A3 when overlapped with the frame part 1a. However, the third opening A3 and the opening of the voltage application member 5 need not have a similar shape in an exemplary aspect.

The third opening A3 is in communication with the first opening A1 and the second opening A2 in the first direction D1. The vibration part 1b has a fourth opening A4. The fourth opening A4 communicates with the second opening A2 in the first direction D1. The forms of the third opening A3 and the fourth opening A4 are not limited to this. For example, the third opening A3 needs not communicate with the first opening A1. As described later, the fourth opening A4 needs not communicate with the second opening A2.

In each connection member, as illustrated in FIG. 6(B), the coupling part 3a₃ is narrower in width than the first plate-shaped part 3a₁ having the same width as that of the piezoelectric member 2. However, the exemplary aspect is not limited to this configuration. For example, the first plate-shaped part 3a₁ and the coupling part 3a₃ may have the same width, and the coupling part 3a₃ may have the bent part mentioned earlier.

The second plate-shaped part 3a₂ of the first part 3a of the first connection member 3 is connected to the periphery of the third opening A3 on the first main surface of the frame part 1a in the form of a double-supported beam with the voltage application member 5 interposed therebetween. Similarly, a second plate-shaped part 3b₂ not illustrated of the second part 3b of the first connection member 3 is connected to the periphery of the third opening A3 on the second main surface of the frame part 1a in the form of a double-supported beam with the voltage application member 5 interposed therebetween.

A second plate-shaped part 4a₂ not illustrated of the first part 4a of the second connection member 4 is connected to the periphery of the fourth opening A4 on the first main surface of the vibration part 1b in the form of a double-supported beam with fixing members 6a₁ and 6a₂ interposed therebetween. Furthermore, a second plate-shaped part 4b₂ not illustrated of the second part 4b of the second connection member 4 is connected to the periphery of the fourth opening A4 on the second main surface of the vibration part 1b in the form of a double-supported beam with fixing members 6b₁ and 6b₂ not illustrated interposed therebetween.

In operation, the voltage is applied to the piezoelectric member 2 in the vibration structure 100D from the voltage application member 5 described later with the first part 3a and the second part 3b of the first connection member 3 interposed therebetween, similarly to the vibration structure 100. However, a voltage supply path other than this may be used in alternative aspects.

By elastic deformation of the first part 3a and the second part 3b of the first connection member 3 and the first part 4a and the second part 4b of the second connection member 4, which are elastic bodies, the vibration structure 100D can also suppress generation of tensile stress in the piezoelectric member 2 when receiving impact, similarly to that mentioned earlier. In particular, in the vibration structure 100D, each vibration member has a T-shaped structure as illustrated in FIG. 6(B). Therefore, the second plate-shaped part of each vibration member easily sags in the first direction D1 by the impact received by the vibration structure 100D. Therefore, damage of the piezoelectric member 2 can be prevented when receiving impact. In addition, in a case where the width of the coupling part of each connection part is narrower than the width of the first plate-shaped part, the coupling part also easily elastically deforms. Therefore, it is possible to more effectively suppress damage of the piezoelectric member 2.

In the vibration structure 100D, connection members are connected to the first end and the second end of the first main surface of the piezoelectric member 2 and the first end and the second end of the second main surface facing back-to-back to the first main surface. Therefore, the first main surface and the second main surface can effectively balance the stress generated in each of the connected connection members. Therefore, when each connection member expands and contracts due to the impact received by the vibration structure 100D, particularly when the connection members contract, it is possible to effectively suppress generation of force for sagging the piezoelectric member 2 in a normal direction of the vibration part 1b. As a result, damage due to sagging of the piezoelectric member 2 can be prevented particularly when a piezoelectric ceramic material is used as the material of the piezoelectric member 2.

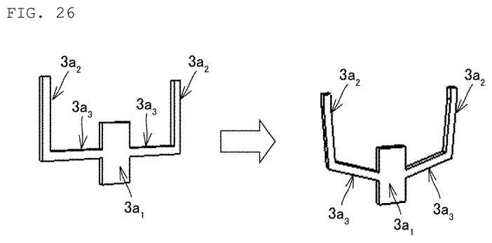

The coupling part has a T-shape in FIGS. 6(A) and 6(B), but exemplary aspect is not limited to this configuration. For example, the vibration structure 100D-2 illustrated in FIGS. 25 and 26 may be adopted. The vibration structure 100D-2 is different from the vibration structure 100D in the forms of the connection member 3, the connection member 4, and an opening A3 frame (see FIG. 1). Since the other configurations are similar to those of the vibration structure 100D, redundant description is not be repeated.

As illustrated in FIG. 25, the vibration structure 100D-2 also includes the first part 3a and the second part 3b of the first connection member 3 and the first part 4a and the second part 4b of the second connection member 4 as connection members. However, as illustrated in FIG. 26, each connection member in the vibration structure 100D-2 has a shape including the first plate-shaped part 3a₁ connected to the first end of the first electrode 2b of the piezoelectric member 2, the second plate-shaped part 3a₂ extending along the first direction D1 on both sides of the first plate-shaped part 3a₁ and connected to the frame part 1a, and the coupling part 3a₃ extending from both side surfaces of the first plate-shaped part 3a₁ along a substantially orthogonal direction to the first direction D1 and coupling the second plate-shaped part 3a₂. Also in a case where each connection member has this shape, the second plate-shaped part of each vibration member easily sags in the first direction D1 by the impact received by the vibration structure 100D-2, and therefore a similar effect can be obtained. In the example illustrated in FIG. 25, the first opening A1 also serves as the third opening A3.

Fifth Modification of Vibration Structure—

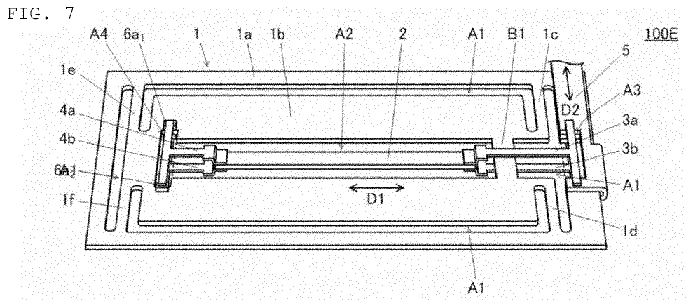

The fifth modification of the vibration structure 100, which is a schematic form of the vibration structure according to the present disclosure, will be described with reference to FIG. 7. FIG. 7 is a perspective view of the vibration structure 100E, which is the fifth modification of the vibration structure 100. The vibration structure 100E is different from the vibration structure 100D in the vibration part 1b and the form of each connection member (see FIGS. 6(A) and 6(B)). Since the other configurations are similar to those of the vibration structure 100D, redundant description is omitted.

As illustrated in FIG. 7, the vibration structure 100E also includes the first part 3a and the second part 3b of the first connection member 3 and the first part 4a and the second part 4b of the second connection member 4 as connection members. Similarly to the vibration structure 100D, each connection member in the vibration structure 100E has a T-shape including the first plate-shaped part 3a₁ connected to the first end of the first electrode 2b of the piezoelectric member 2, the second plate-shaped part 3a₂ extending along the second direction D2 orthogonal to the first direction D1 and connected to the frame part 1a, and the coupling part 3a₃ coupling the first plate-shaped part 3a₁ and the second plate-shaped part 3a₂. In each connection member, the coupling part 3a₃ is narrower in width than the first plate-shaped part 3a₁ having the same width as that of the piezoelectric member 2.

That is, by elastic deformation of the first part 3a and the second part 3b of the first connection member 3 and the first part 4a and the second part 4b of the second connection member 4, which are elastic bodies, the vibration structure 100E can also suppress generation of tensile stress in the piezoelectric member 2 when receiving impact, as mentioned earlier. Therefore, it is possible to effectively suppress damage of the piezoelectric member 2 when receiving impact. In addition, in a case where the width of the coupling part of each connection part is narrower than the width of the first plate-shaped part, the coupling part also easily elastically deforms. Therefore, it is possible to more effectively suppress damage of the piezoelectric member 2.

In operation, the voltage is applied to the piezoelectric member 2 in the vibration structure 100E from the voltage application member 5 described later with the first part 3a and the second part 3b of the first connection member 3 interposed therebetween, similarly to the vibration structure 100. However, a voltage supply path other than this may be used in alternative aspects.

Furthermore, the first part 3a and the second part 3b of the first connection member 3 have a first step between a part connected to the frame part 1a and a part connected to the piezoelectric member 2. In the vibration structure 100E, the first plate-shaped part of the first part 3a and the second part 3b of the first connection member 3 is provided with a first step.

The first part 4a and the second part 4b of the second connection member 4 have a second step between a part connected to the vibration part 1b and a part connected to the piezoelectric member 2. In the vibration structure 100E, the first plate-shaped part of the first part 4a and the second part 4b of the second connection member 4 is provided with the second step. However, the site provided with the first step and the second step is not limited to this configuration. For example, the coupling part or the second plate-shaped part of the first part 3a and the second part 3b of the first connection member 3 may be provided with the first step. Similarly, the coupling part or the second plate-shaped part of the first part 4a and the second part 4b of the second connection member 4 may be provided with the second step. It is also noted that the present structure of the exemplary aspect is not limited to a case where the coupling part has a T-shape. The coupling part may have the shape of FIG. 100D-2 or may have another shape in alternative aspects.

When each connection member is flat, it is necessary to increase the thickness of the piezoelectric member 2 by the thickness of the voltage application member 5. On the other hand, by providing each connection member with a step, it is possible to reduce the thickness of the piezoelectric member 2. The step of each connection member is useful particularly when the thickness of the piezoelectric member 2 is thinner than the thickness of the vibration part 1b. However, the exemplary aspect is not limited to this configuration.

Furthermore, the vibration part 1b has a first beam B1 that is held between the first part 3a and the second part 3b of the first connection member 3 and separates the first opening A1 from the second opening A2. When the vibration structure 100E receives impact such that the vibration part 1b is displaced in the normal direction of each main surface, this first beam B1 comes into contact with at least one of the deformed connection members. In this case, the first beam B1 serves as a suppression member of deformation of each main surface of the vibration part 1b of each connection member in the normal direction.

For example, when the first part 3a of the first connection member 3 and the first beam B1 come into contact with each other, a part of the first part 3a of the first connection member 3 extending along the first direction D1, the part on the piezoelectric member 2 side relative to a place coming into contact with the first beam B1, is displaced following the displacement of the vibration part 1b. Therefore, the piezoelectric member 2 is also displaced following the displacement of the vibration part 1b. Therefore, the generation of force for sagging the piezoelectric member 2 in the normal direction of each main surface of the vibration part 1b can effectively be suppressed. As a result, it is possible to effectively suppress damage due to sagging of the piezoelectric member 2 particularly when a piezoelectric ceramic material is used as the material of the piezoelectric member 2.

Sixth Modification of Vibration Structure—

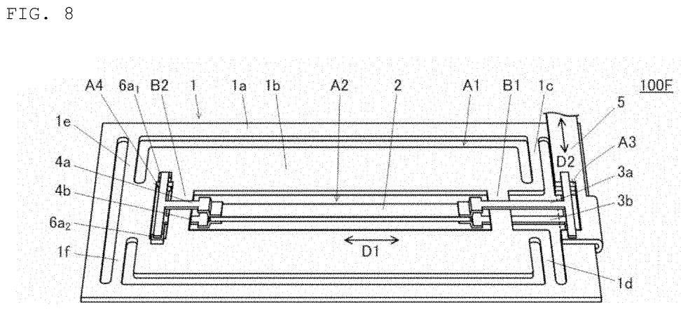

The sixth modification of the vibration structure 100, which is a schematic form of the vibration structure according to the present disclosure, will be described with reference to FIG. 8. FIG. 8 is a perspective view of the vibration structure 100F, which is the sixth modification of the vibration structure 100. The vibration structure 100F is different from the vibration structure 100E in the form of the vibration part 1b (see FIG. 7). Since the other configurations are similar to those of the vibration structure 100E, redundant description is omitted.

In the vibration structure 100F, as illustrated in FIG. 8, the vibration part 1b has, in addition to the above-described first beam B1, a second beam B2 that is held between the first part 4a and the second part 4b of the second connection member 4 and separates the second opening A2 from the fourth opening A4. When the vibration structure 100F receives impact such that the vibration part 1b is displaced in the normal direction of each main surface, the first beam B1 achieves a similar effect to that of the vibration structure 100E. Then, the second beam B2 comes into contact with at least one of the connection members that deform. In this case, similarly to the first beam B1, the second beam B2 also serves as a suppression member of deformation of each main surface of the vibration part 1b of each connection member in the normal direction.

For example, when the first part 4a of the second connection member 4 and the second beam B2 come into contact with each other, a part of the first part 4a of the second connection member 4 extending along the first direction D1, the part on the piezoelectric member 2 side relative to the place coming into contact with the second beam B2, is displaced following the displacement of the vibration part 1b. Therefore, the piezoelectric member 2 is also displaced following the displacement of the vibration part 1b. Therefore, it is possible to effectively suppress generation of force for sagging the piezoelectric member 2 in the normal direction of each main surface of the vibration part 1b. As a result, damage due to sagging of the piezoelectric member 2 can be effectively prevented particularly when a piezoelectric ceramic material is used as the material of the piezoelectric member 2.

Seventh Modification of Vibration Structure—

The seventh modification of the vibration structure 100, which is a schematic form of the vibration structure according to the present disclosure, will be described with reference to FIGS. 9(A) and 9(B). FIG. 9(A) is a perspective view of the vibration structure 100G, which is the seventh modification of the vibration structure 100. The vibration structure 100G is different from the vibration structure 100D in the forms of the support parts 1c to 1f and the second plate-shaped part 3a₂ of each connection member (see FIGS. 6(A) and 6(B)). Since the other configurations are similar to those of the vibration structure 100D, redundant description is omitted.

In the vibration structure 100G, as illustrated in FIG. 9(A), the support parts 1c to 1f have a wide V-shaped bent part. When the vibration structure 100G receives impact such that the vibration part 1b is displaced along the second direction D2, the bent parts of the support parts 1c to 1f are planar springs that increase the stretchability of the support parts 1c to 1f along the second direction D2. In FIG. 9(A), the bent part of each support part has a wide V-shape, but is not limited to this. The bent part of each support part is provided such that each V-shaped opening site opposes the vibration part 1b. In this case, it is possible to balance the force that displaces the vibration member 1 along the first direction D1 that is generated by expansion and contraction of each support part.

Moreover, the second plate-shaped part 3a₂ of each connection member has a wide V-shaped bent part on each of both sides of the connection place with the coupling part 3a₃. Similarly to the above-described configuration, when the vibration structure 100G receives impact such that the vibration part 1b is displaced along the second direction D2, the bent part of the second plate-shaped part 3a₂ is a planar spring that enhances the stretchability of the part along the second direction D2. In FIG. 9(A), the bent part of each connection member has a wide V-shape, but is not limited to this.

The bent part of each connection member is provided such that each V-shaped sharp site faces the side of the part extending along the first direction D1. That is, the orientation of the V-shape of the bent part is reversed between the support parts 1c to 1f and the second plate-shaped part 3a₂ of each connection member. Also, in this case, the force that displaces the piezoelectric member 2 along the first direction D1 that is generated by expansion and contraction of the second plate-shaped part 3a₂ of each connection member can be balanced.

FIG. 9(B) is a plan view illustrating expansion and contraction of the bent part of each support part, expansion and contraction of the bent part of the second plate-shaped part 3a₂ of each connection member, and deformation of the first part 3a of the first connection member 3 due to the impact received along the second direction D2 by the vibration structure 100G.

It is assumed that, from the state of the upper drawing of FIG. 9(B), the vibration structure 100G receives impact such that the vibration part 1b is relatively displaced in an orientation from the side where the support parts 1d and 1f are arranged toward the side where the support parts 1c and 1e are arranged along the second direction D2 as in the lower drawing of FIG. 9(B). In this case, the bent parts of the support parts 1c and 1e and the bent parts on the support parts 1c and 1e side of the second plate-shaped part 3a₂ of each connection member contract. Then, the bent parts of the support parts 1d and 1f and the bent parts on the support parts 1d and 1f side of the second plate-shaped part 3a₂ of each connection member stretch.

That is, the vibration structure 100G can displace the vibration part 1b while suppressing sagging of the piezoelectric member 2 in the second direction D2 until a side surface of the vibration part 1b comes into contact with an inner wall surface of the opposing frame part 1a and the side surface of the piezoelectric member 2 comes into contact with the inner wall surface of the opposing second opening A2. As a result, damage due to sagging of the piezoelectric member 2 can effectively be suppressed particularly when a piezoelectric ceramic material is used as the material of the piezoelectric member 2.

Eighth Modification of Vibration Structure—

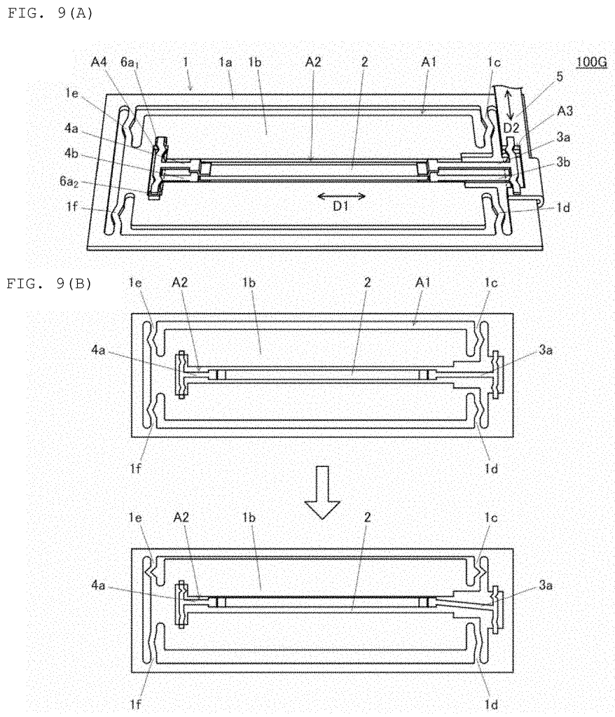

The eighth modification of the vibration structure 100, which is a schematic form of the vibration structure according to an exemplary aspect, will be described with reference to FIG. 10. FIG. 10 is a perspective view of the vibration structure 100H, which is the eighth modification of the vibration structure 100. The vibration structure 100H is different from the vibration structure 100G in the form of the vibration part 1b (see FIGS. 9(A) and 9(B)). Since the other configurations are similar to those of the vibration structure 100G, redundant description is omitted.

In the vibration structure 100H, as illustrated in FIG. 10, similarly to the vibration structure 100E, the vibration part 1b has a first beam B1 that is held between the first part 3a and the second part 3b of the first connection member 3 and separates the first opening A1 from the second opening A2. When the vibration structure 100H receives impact such that the vibration part 1b is displaced in the normal direction of each main surface, the first beam B1 achieves a similar effect to that of the vibration structure 100E. That is, the first beam B1 serves as a suppression member of deformation of each main surface of the vibration part 1b of each connection member in the normal direction.

For example, when the first part 3a of the first connection member 3 and the first beam B1 come into contact with each other, a part of the first part 3a of the first connection member 3 extending along the first direction D1, the part on the piezoelectric member 2 side relative to a place coming into contact with the first beam B1, is displaced following the displacement of the vibration part 1b. Therefore, the piezoelectric member 2 is also displaced following the displacement of the vibration part 1b. Therefore, the generation of force for sagging the piezoelectric member 2 in the normal direction of each main surface of the vibration part 1b can effectively be suppressed. As a result, damage due to sagging of the piezoelectric member 2 can be prevented particularly when a piezoelectric ceramic material is used as the material of the piezoelectric member 2.

Ninth Modification of Vibration Structure—

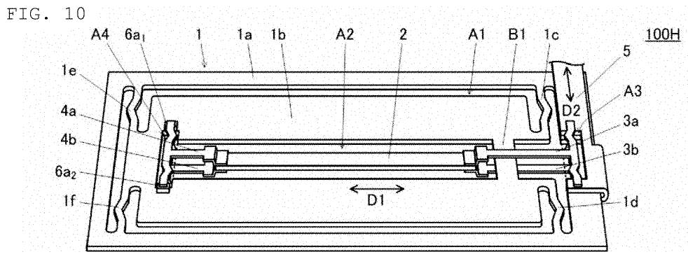

The ninth modification of the vibration structure 100, which is a schematic form of the vibration structure according to the present disclosure, will be described with reference to FIG. 11S 11(A) and 11(B). FIG. 11(A) is a perspective view of the vibration structure 100I, which is the ninth modification of the vibration structure 100. FIG. 11(B) is a sectional view of the vibration structure 100I taken along a plane including line X2-X2 illustrated in FIG. 11(A), as viewed in the direction of arrows. In addition to the constituent members of the vibration structure 100F, the vibration structure 100I further includes a covering member that covers a predetermined one of those constituent members and a buffer member (see FIG. 8). Since the other configurations are similar to those of the vibration structure 100F, redundant description is omitted.

The vibration structure 100I further includes a first covering member 7, a second covering member 8, a third covering member 9, and a first buffer member 10. The first covering member 7 includes a first part 7a and a second part 7b. The second covering member 8 includes a first part 8a and a second part 8b. The third covering member 9 includes a first part 9a and a second part 9b. The first buffer member 10 includes a first part 10a and a second part 10b.

The first part 7a of the first covering member 7 is connected to the first main surface of the vibration part 1b so as to straddle the second opening A2, and covers at an interval a part of the surface of the piezoelectric member 2 on the first main surface side of the vibration part 1b. The first part 10a of the first buffer member 10 is inserted between the piezoelectric member 2 and the first part 7a of the first covering member 7. The first part 10a of the first buffer member 10 is fixed to the first part 7a of the first covering member 7. The piezoelectric member 2 and the first part 10a of the first buffer member 10 are in contact with each other, but there may be a gap therebetween. In the vibration structure 100I, the first part 7a of the first covering member 7 covers a part where the piezoelectric member 2 is exposed between a connection place between the piezoelectric member 2 and the first part 3a of the first connection member 3 and the connection place between the piezoelectric member 2 and the first part 4a of the second connection member 4.

The second part 7b of the first covering member 7 is connected to the second main surface of the vibration part 1b so as to straddle the second opening A2, and covers at an interval a part of the surface of the piezoelectric member 2 on the second main surface side of the vibration part 1b. The second part 10b of the first buffer member 10 is inserted between the piezoelectric member 2 and the second part 7b of the first covering member 7. The second part 10b of the first buffer member 10 is fixed to the second part 7b of the first covering member 7. The piezoelectric member 2 and the second part 10b of the first buffer member 10 are in contact with each other, but there may be a gap therebetween. In the vibration structure 100I, the second part 7b of the first covering member 7 covers a part where the piezoelectric member 2 is exposed between a connection place between the piezoelectric member 2 and the second part 3b of the first connection member 3 and a connection place between the piezoelectric member 2 and the second part 4b of the second connection member 4.

When the vibration structure 100I receives impact such that the vibration part 1b is displaced in the normal direction of each main surface, deformation of each main surface of the piezoelectric member 2 in the normal direction is suppressed by the first part 7a of the first covering member 7 and the first part 10a of the first buffer member 10, or the second part 7b of the first covering member 7 and the second part 10b of the first buffer member 10. This configuration reduces the stress applied to the connection place between the piezoelectric member 2 and each connection member. As a result, separation between the piezoelectric member 2 and each connection member can be suppressed.

It is noted that the first part 10a of the first buffer member 10 needs not be inserted between the piezoelectric member 2 and the first part 7a of the first covering member 7. Similarly, the second part 10b of the first buffer member 10 needs not be inserted between the piezoelectric member 2 and the second part 7b of the first covering member 7. In these cases, the piezoelectric member 2 is only required to come into contact with the first part 10a and the second part 10b from the beginning, or is only required to come into contact with at least one of the first part 10a and the second part 10b in the process of deformation of each connection member. However, as described above, it is preferable that the first part 10a of the first buffer member 10 is inserted between the piezoelectric member 2 and the first part 7a of the first covering member 7, the second part 10b of the first buffer member 10 is inserted between the piezoelectric member 2 and the second part 7b of the first covering member 7, and the piezoelectric member 2 is pressed by each buffer member.

As a material of the first covering member 7, metal or the like can be used, for example. When metal is used, stainless steel, a tungsten alloy, a titanium alloy, or the like, is preferable. From the above viewpoint, as a material of the first buffer member 10, it is possible to use a material having a Young's modulus (or a secant coefficient) of equal to or more than 10³ Pa and equal to or less than 10⁹ Pa. For example, rubber, polytetrafluoroethylene, polyethylene, polypropylene, polystyrene, polycarbonate, nylon, and the like are preferable.

It is preferable that the first part 7a of the first covering member 7 fully covers the surface of the piezoelectric member 2 on the first main surface side of the vibration part 1b, including from the connection place between the piezoelectric member 2 and the first part 3a of the first connection member 3 to the connection place between the piezoelectric member 2 and the first part 4a of the second connection member 4. It is also preferable that the second part 7b of the first covering member 7 fully covers the surface of the piezoelectric member 2 on the second main surface side of the vibration part 1b, including from the connection place between the piezoelectric member 2 and the second part 3b of the first connection member 3 to the connection place between the piezoelectric member 2 and the second part 4b of the second connection member 4. Furthermore, it is more preferable that each part of the first covering member 7 covers up to the first beam B1. It is still more preferable that in that state, the first part 10a of the first buffer member 10 is inserted between the piezoelectric member 2 and the first part 7a of the first covering member 7, and the second part 10b of the first buffer member 10 is inserted between the piezoelectric member 2 and the second part 7b of the first covering member 7.

In these cases, the stress applied to the connection place between the piezoelectric member 2 and each connection member is further reduced. As a result, it is possible to further suppress separation between the piezoelectric member 2 and each connection member.

The first part 8a of the second covering member 8 is connected to the frame part 1a so as to cover at an interval a ridge line between, among the side surfaces connecting the first main surface and the second main surface of the vibration part 1b, the first side surface that is on the support parts 1c and 1e side and opposes the frame part 1a and the first main surface. The second part 8b of the second covering member 8 is connected to the frame part 1a so as to cover at an interval a ridge line between the first side surface and the second main surface of the vibration part 1b. That is, the first part 8a and the second part 8b of the second covering member 8 are arranged to oppose each other with the frame part 1a interposed therebetween, and form a groove extending along the first direction D1 together with the frame part 1a (see FIG. 11(B)). Then, the first side surface of the vibration part 1b and a part of each main surface continuous therewith enter the groove. It is preferable that the first part 8a and the second part 8b of the second covering member 8 fully cover the first side surface of the vibration part 1b. However, a part of the first side surface of the vibration part 1b may be exposed.

The first part 9a of the third covering member 9 is connected to the frame part 1a so as to cover at an interval a ridge line between, among the side surfaces connecting the first main surface and the second main surface of the vibration part 1b, the second side surface that is on the support parts 1d and 1f side, opposes the frame part 1a, and faces back-to-back to the first side surface and the first main surface. The second part 9b of the third covering member 9 is connected to the frame part 1a so as to cover at an interval a ridge line between the second side surface and the second main surface of the vibration part 1b. That is, the first part 9a and the second part 9b of the third covering member 9 are arranged to oppose each other with the frame part 1a interposed therebetween, and form a groove extending along the first direction D1 together with the frame part 1a (see FIG. 11(B)). Then, the second side surface of the vibration part 1b and a part of each main surface continuous therewith enter the groove. It is preferable that the first part 9a and the second part 9b of the third covering member 9 fully cover the second side surface of the vibration part 1b. However, a part of the second side surface of the vibration part 1b may be exposed.

When the vibration structure 100I receives impact such that the vibration part 1b is displaced in the normal direction of each main surface, the vibration part 1b can be displaced until a part of each main surface of the vibration part 1b in the groove comes into contact with the inner wall surface of the groove. However, further displacement is suppressed by each covering member forming the groove. This configuration suppresses sagging of the piezoelectric member 2 in the second direction D2. As a result, damage due to sagging of the piezoelectric member 2 can effectively be suppressed particularly when a piezoelectric ceramic material is used as the material of the piezoelectric member 2. It is possible to suppress separation between the piezoelectric member 2 and each bonding member. When the first covering member 7 is connected to the vibration part 1b, the above effect can be remarkably obtained.

Tenth Modification of Vibration Structure—

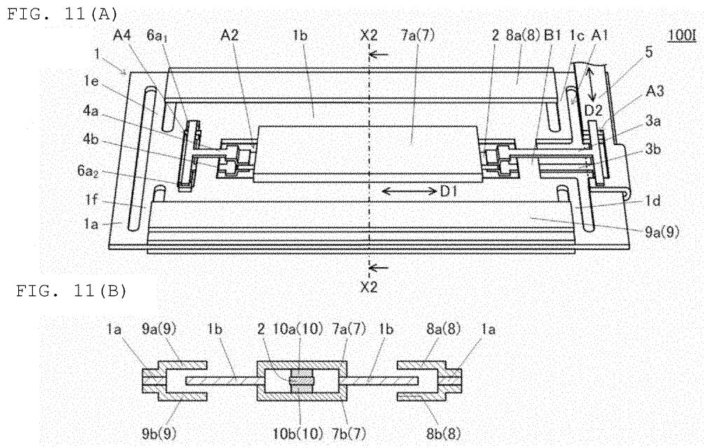

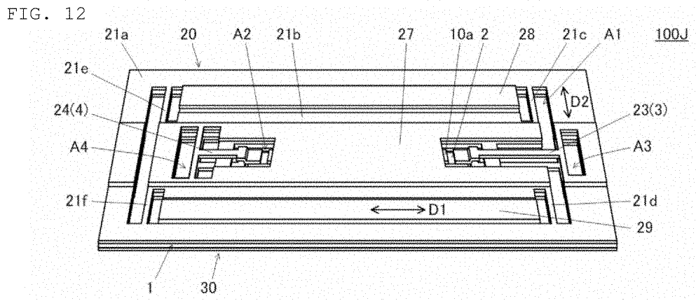

The tenth modification of the vibration structure 100, which is a schematic form of the vibration structure according to the present disclosure, will be described with reference to FIGS. 12 and 13. FIG. 12 is a perspective view of the vibration structure 100J, which is the tenth modification of the vibration structure 100. FIG. 13 is an exploded perspective view of the vibration structure 100J. The vibration structure 100J includes constituent members basically similar to those of the vibration structure 100I. However, it is different from the vibration structure 100I in that the individual constituent members are brought together into three members (see FIGS. 11(A) and 11(B)). Therefore, although the reference symbols given in the drawings are different, only the correspondence relationship is described for those corresponding to the constituent members of the vibration structure 100I, and redundant description is omitted. Similarly, redundant description of common constituent members is also omitted.

As illustrated in FIGS. 12 and 13, the vibration structure 100J includes the vibration member 1, the piezoelectric member 2, a first composite member 20, a second composite member 30, and the first buffer member 10. The first buffer member 10 includes the first part 10a and the second part 10b.

The vibration member 1 includes a first partial frame part 11a, a first partial vibration part 11b, and first partial support parts 11c to 11f, and they are integrally formed. Each constituent member described above can be formed by punching one rectangular plate member such that these sites remain.

The first partial frame part 11a forms the frame part 1a, the first partial vibration part 11b forms the vibration part 1b, and the first partial support parts 11c to 11f form the support parts 1c to 1f. The vibration member 1 has a first partial opening A13 constituting the third opening A3 in the frame part 1a, and has a second partial opening A14 forming the fourth opening A4 in the vibration part 1b.

The vibration structure 100J is connected to a circuit or a device that applies voltage to the piezoelectric member 2, such as the drive circuit 200, with the voltage application member 5 interposed therebetween. It is noted that the voltage application member 5 and the drive circuit 200 are not illustrated in FIGS. 12 and 13.

The first composite member 20 includes a second partial frame part 21a, a second partial vibration part 21b, second partial support parts 21c to 21f, a first part 23 of the first connection member 3 and a first part 24 of the second connection member 4, a first part 27 of the first covering member 7, a first part 28 of the second covering member 8, and a first part 29 of the third covering member 9, and they are integrally formed. 23 of the first part of the first connection member 3 and the first part 24 of the second connection member 4 each have a first step. Each constituent member described above can be formed by punching and bending one rectangular plate member such that these sites remain.

That is, there is a third step between the second partial vibration part 21b and the first part 27 of the first covering member 7, the first part 28 of the second covering member 8, and the first part 29 of the third covering member 9. Therefore, in a state where the vibration member 1 and the first composite member 20 are integrated, it is possible to insert the first part 10a of the first buffer member 10 into a space formed between the piezoelectric member 2 and the first part 27 of the first covering member 7 by the third step. The first part 28 of the second covering member 8 can cover a ridge line of the first side surface of the first partial vibration part 11b opposing the first partial frame part 11a at interval, and the first part 29 of the third covering member 9 can cover a ridge line of the second side surface at interval.

Therefore, it is not necessary to hold, between the vibration member 1 and the first composite member 20, a spacer for creating the space, and the number of constituent members of the vibration structure can be reduced to simplify the manufacturing process.

The second partial frame part 21a forms the frame part 1a, the second partial vibration part 21b forms the vibration part 1b, and the second partial support parts 21c to 21f form the support parts 1c to 1f. The first composite member 20 has a third partial opening A23 forming the third opening A3 and a fourth partial opening A24 forming the fourth opening A4.

The second composite member 30 includes a third partial frame part 31a, a third partial vibration part 31b, third partial support parts 31c to 31f, a second part 33 of the first connection member 3 and a second part 34 of the second connection member 4, a second part 37 of the first covering member 7, a second part 38 of the second covering member 8, and a second part 39 of the third covering member 9, and they are integrally formed. 33 of the second part of the first connection member 3 and the second part 34 of the second connection member 4 each have a second step. Similarly to the first composite member 20, each constituent member described above can be formed by punching and bending one rectangular plate member such that these sites remain.

That is, there is a fourth step between the third partial vibration part 31b and the second part 37 of the first covering member 7, the second part 38 of the second covering member 8, and the second part 39 of the third covering member 9. Therefore, in a state where the vibration member 1 and the second composite member 30 are integrated, it is possible to insert the second part 10b of the first buffer member 10 into a space formed between the piezoelectric member 2 and the second part 37 of the first covering member 7 by the fourth step. The second part 38 of the second covering member 8 can cover a ridge line of the first side surface of the first partial vibration part 11b opposing the first partial frame part 11a at interval, and the second part 39 of the third covering member 9 can cover a ridge line of the second side surface at interval.

Therefore, it is not necessary to hold, between the vibration member 1 and the second composite member 30, a spacer for creating the space, and the number of constituent members of the vibration structure can be reduced to simplify the manufacturing process.

The third partial frame part 31a forms the frame part 1a, the third partial vibration part 31b forms the vibration part 1b, and the third partial support parts 31c to 31f form the support parts 1c to 1f. The second composite member 30 has a fifth partial opening A33 forming the third opening A3 and a sixth partial opening A34 forming the fourth opening A4 (see FIG. 13 above).

The vibration member 1, the piezoelectric member 2, and the first part 10a and the second part 10b of the first buffer member 10 are held between the first composite member 20 and the second composite member 30. In a state where the vibration member 1, the first composite member 20, and the second composite member 30 are integrated to form the vibration structure 100J (see FIG. 12), the partial frame parts are integrated to form the frame part 1a. Similarly, the partial vibration parts are integrated into the vibration part 1b, and the respective partial support parts are integrated into the support parts 1c to 1f.

The vibration structure 100J can obtain a similar effect to that of the vibration structure 100I. Furthermore, the constituent members are not individually produced but are collectively produced into the vibration member 1, the first composite member 20, and the second composite member 30. Therefore, it is possible to eliminate complexity of individually producing the constituent members. Also, when the vibration structure is downsized and the constituent members are downsized accordingly, by bringing them together, it is possible to produce the vibration structure. The first composite member 20 and the second composite member 30 may have basically the identical structure. That is, they are in a relationship of being upside down. In this case, it is possible to omit separate production of both.

In the vibration structure 100J, the vibration member 1 may be omitted. In this case, the vibration part 1b is configured to include the second partial vibration part 21b of the first composite member 20 and the first part 27 of the first covering member 7, and the third partial vibration part 31b of the second composite member 30 and the second part 37 of the first covering member 7. Even if the vibration member 1 is omitted, that is, even if the first partial vibration part 11b is omitted, the above-described parts of the first composite member 20 and the second composite member 30 can generate necessary vibration. It is also possible to obtain an effect of relaxing impact. It is possible to further reduce the number of constituent members by omitting the vibration member 1.

Eleventh Modification of Vibration Structure—

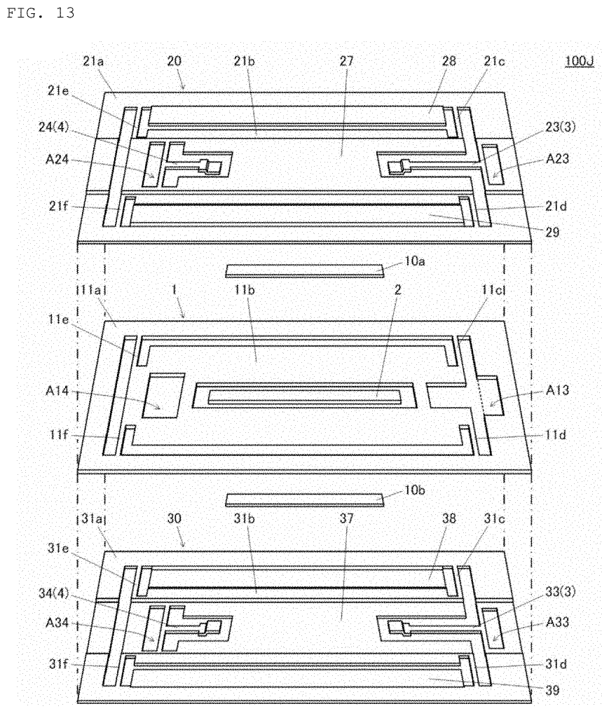

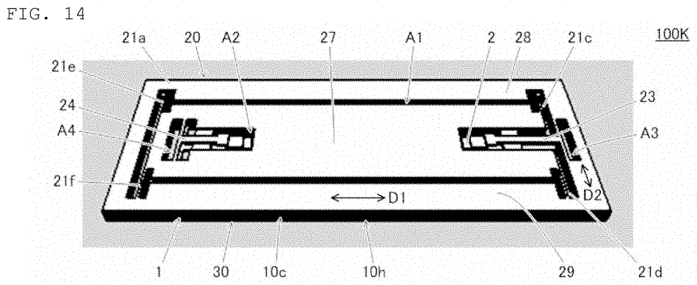

The eleventh modification of the vibration structure 100, which is a schematic form of the vibration structure according to the present disclosure, will be described with reference to FIGS. 14 and 15. FIG. 14 is a perspective view of the vibration structure 100K, which is the eleventh modification of the vibration structure 100. FIG. 15 is an exploded perspective view of the vibration structure 100K. The vibration structure 100K includes constituent members basically similar to those of the vibration structure 100I, and individual constituent members are integrated into three members as the vibration structure 100J. However, the first composite member 20 and the second composite member 30 are in a relationship of being upside down as mentioned earlier. Therefore, in FIG. 15, illustration of the second composite member 30 is omitted.

In the first composite member 20 and the second composite member 30 of the vibration structure 100K, only each connection member is bent to form the above-described step, and the other parts have a flat plate shape. Therefore, the vibration structure 100K further includes spacers for creating the space described in the vibration structure 100J between the vibration member 1 and the first composite member 20 and between the vibration member 1 and the second composite member 30 (see FIG. 15). Since the other configurations are similar to those of the vibration structure 100J, redundant description is omitted.

In the vibration structure 100K, as illustrated in FIGS. 14 and 15, spacers 10c, 10d, and 10e are held between the vibration member 1 and the first composite member 20. The spacer 10c has a frame shape, and is disposed along the side surfaces of the first partial frame part 11a and the second partial frame part 21a. as further shown, the spacers 10d and 10e are strip-shaped, and the spacer 10d is disposed along a first side surface of a part of the first composite member 20 that becomes the first part 27 of the first covering member 7, the first side surface opposing the first part 28 of the second covering member 8. The spacer 10e is disposed along a second side surface of a part that also becomes the first part 27 of the first covering member 7, the second side surface opposing the first part 29 of the third covering member 9.

Similarly, a spacer 10h having the same shape as that of the spacer 10c and spacers 10k and 101 having the same shapes as the spacers 10d and 10e are held between the vibration member 1 and the second composite member 30. These are also not illustrated in FIG. 15. The spacer 10h is disposed along the side surfaces of the first partial frame part 11a and the third partial frame part 31a not illustrated. The spacer 10k is disposed along a first side surface of a part that becomes the second part 37 of the first covering member 7 of the second composite member 30, the first side surface opposing the second part 38 of the second covering member 8. The spacer 10l is disposed along a second side surface of the part that also becomes the second part 37 of the first covering member 7, the second side surface opposing the second part 39 of the third covering member 9.

The vibration structure 100K can obtain similar effects to those of the vibration structure 100I and the vibration structure 100J. Although the number of constituent members increases by the amount of the spacers, the number of places of bending can be reduced. Therefore, the manufacturing time of each composite member can be shortened. Note that also in the vibration structure 100K, the number of constituent members can further be reduced by omitting the vibration member 1. In exemplary aspects, the materials of the first composite member 20 and the second composite member 30 of the vibration structure 100K may be metal or resin, or a board material for circuit wiring may be used. In this case, the part related to the electric wiring can be simplified.

Twelfth Modification of Vibration Structure—

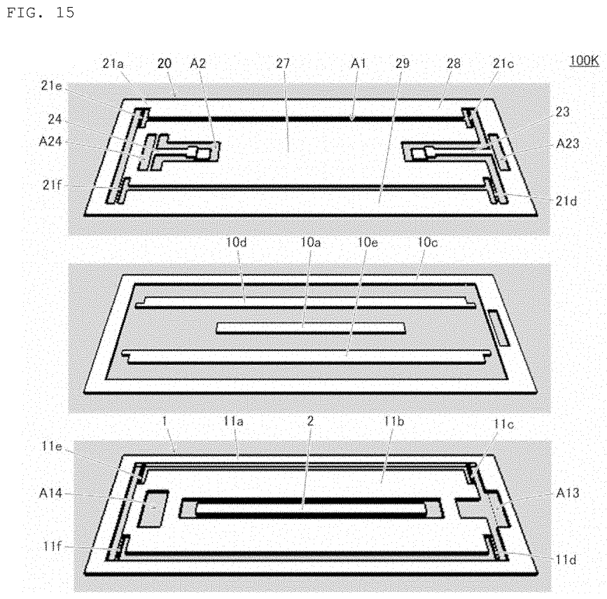

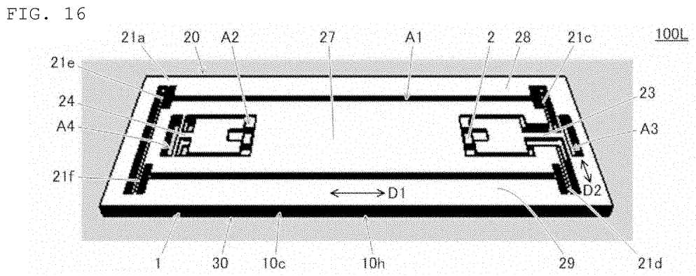

The twelfth modification of the vibration structure 100, which is a schematic form of the vibration structure according to the present disclosure, will be described with reference to FIGS. 16 and 17. FIG. 16 is a perspective view of the vibration structure 100L, which is the twelfth modification of the vibration structure 100. FIG. 17 is an exploded perspective view of the vibration structure 100L. The vibration structure 100L includes constituent members basically similar to those of the vibration structure 100I, and individual constituent members are integrated into three members as the vibration structures 100J and 100K. Also in the vibration structure 100L, the first composite member 20 and the second composite member 30 are in a relationship of being upside down as mentioned earlier. Therefore, in FIG. 15, illustration of the second composite member 30 is omitted.

In the first composite member 20 and the second composite member 30 of the vibration structure 100L, the width of the first plate-shaped part of each bonding member in the second direction D2 is wider than the width of the piezoelectric member 2, and the width of the coupling part in the second direction is narrower than the width of the first plate-shaped part. In the vibration structure 100L, a part of the first plate-shaped part is subjected to drawing, thereby forming a part connected to the piezoelectric member 2. Furthermore, in the vibration structure 100L, a buffer member is inserted between a flat part of the first plate-shaped part and the first partial vibration part 11b, and each spacer for creating a space for that is further included (see FIG. 17). It is noted that since the other configurations are similar to those of the vibration structure 100J, redundant description is omitted.

As illustrated in FIGS. 16 and 17, in the vibration structure 100L, in the first composite member 20, the first plate-shaped part of the first part 23 of the first connection member 3 is formed with a first drawn part, which is a first step, and a bottom of this first drawn part is connected to the piezoelectric member 2. The first plate-shaped part of the first part 24 of the second connection member 4 is formed with a second drawn part, which is a second step, and a bottom of this second drawn part is connected to the piezoelectric member 2. Similarly, in the second composite member 30 not illustrated, the first plate-shaped part of the second part 33 of the first connection member 3 is formed with a first drawn part, which is a first step, and a bottom of this first drawn part is connected to the piezoelectric member 2. The first plate-shaped part of the second part 34 of the second connection member 4 is formed with a second drawn part, which is a second step, and the bottom of this second drawn part is connected to the piezoelectric member 2.

Then, a first part 12a of the second buffer member 12 is inserted between at least a part of a flat part not formed with the first drawn part in the first plate-shaped part of the first part 23 of the first connection member 3 and the first partial vibration part 11b. A first part 13a of the third buffer member 13 is inserted between at least a part of a flat part not formed with the second drawn part of the first plate-shaped part of the first part 24 of the second connection member 4 and the first partial vibration part 11b. The first part 12a of the second buffer member 12 and the first part 13a of the third buffer member 13 have an angular C-shape and are arranged along three sides of the plate-shaped part. However, the exemplary aspects of the present disclosure are not limited to this configuration.

Furthermore, the spacers 10c, 10d, and 10e are held between the vibration member 1 and the first composite member 20. The shape and the arrangement position of each spacer are similar to those of the vibration structure 100K.

Similarly, a second part 12b of the second buffer member 12 not illustrated is inserted between at least a part of a flat part not formed with the first drawn part in the first plate-shaped part of the second part 33 of the first connection member 3 not illustrated and the first partial vibration part 11b. A second part 13b of the third buffer member 13 not illustrated is inserted between at least a part of a flat part not formed with the second drawn part in the first plate-shaped part of the second part 34 of the second connection member 4 not illustrated and the first partial vibration part 11b. The second part 12b of the second buffer member 12 and the second part 13b of the third buffer member 13 also have an angular C-shape and are arranged along three sides of the plate-shaped part. However, it is noted that the exemplary aspect is not limited to this configuration.

Furthermore, the spacer 10h and the spacers 10k and 101 not illustrated are held between the vibration member 1 and the first composite member 20. The shape and the arrangement position of each spacer are similar to those of the vibration structure 100K.

In the vibration structure 100L, the buffer member is inserted between at least a part of the flat part of the plate-shaped part of each connection member and the first partial vibration part 11b. As a result, it is possible to more effectively suppress damage due to sagging of the piezoelectric member 2 particularly when a piezoelectric ceramic material is used as the material of the piezoelectric member 2. Although the number of constituent members increases by the amount of the spacers, the number of places of bending can be reduced. Therefore, the manufacturing time of each composite member can be shortened. Note that also in the vibration structure 100L, the number of constituent members can be reduced by omitting the vibration member 1. The structures of the first connection member 3, the second connection member 4, the second buffer member 12, and the first partial vibration part 11b in the vibration structure 100L can be added to any structure of the vibration structures 100A to 100I in which the composite member is not used.

Thirteenth Modification of Vibration Structure—

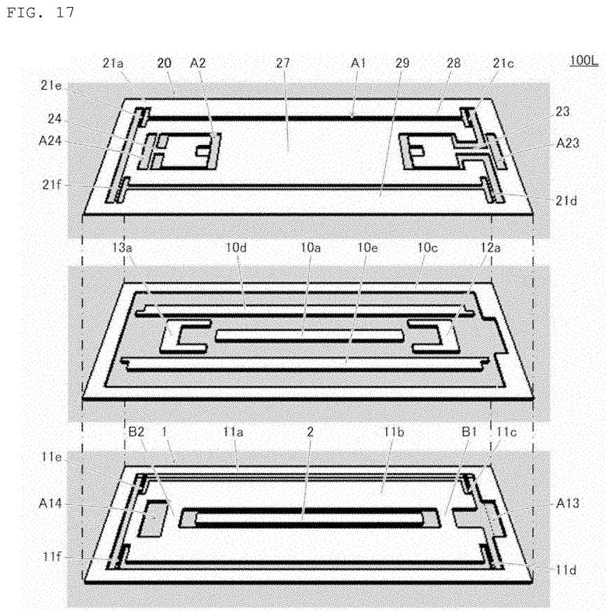

The thirteenth modification of the vibration structure 100, which is a schematic form of the vibration structure according to the present disclosure, will be described with reference to FIGS. 18 and 19. FIG. 18 is a perspective view of the vibration structure 100M, which is the thirteenth modification of the vibration structure 100. FIG. 19 is an exploded perspective view of the vibration structure 100M. The vibration structure 100M includes constituent members basically similar to those of the vibration structure 100I, and individual constituent members are integrated into three members as the vibration structures 100J and 100K. Also in the vibration structure 100M, the first composite member 20 and the second composite member 30 are in a relationship of being upside down as mentioned earlier. Therefore, in FIG. 19, illustration of the second composite member 30 is omitted.

As illustrated in FIGS. 18 and 19, also in the first composite member 20 and the second composite member 30 of the vibration structure 100M, a part of the first plate-shaped part of each connection member is subjected to drawing similar to that of the vibration structure 100L, thereby forming a part connected to the piezoelectric member 2. That is, in the first composite member 20, the first plate-shaped part of the first part 23 of the first connection member 3 is formed with the first drawn part, which is a first step, and the first plate-shaped part of the first part 24 of the second connection member 4 is formed with the second drawn part, which is the second step. Similarly, in the second composite member 30 not illustrated, the first plate-shaped part of the second part 33 of the first connection member 3 is formed with the first drawn part, which is a first step, and the first plate-shaped part of the second part 34 of the second connection member 4 is formed with the second drawn part, which is a second step.

In the first composite member 20, similarly to the vibration structure 100J, one rectangular plate member is bent such that the third step is formed between the second partial vibration part 21b and the first part 27 of the first covering member 7, the first part 28 of the second covering member 8, and the first part 29 of the third covering member 9 (see FIG. 19). Also in the second composite member 30, one rectangular plate member is bent such that the fourth step is formed between the third partial vibration part 31b and the second part 37 of the first covering member 7, the second part 38 of the second covering member 8, and the second part 39 of the third covering member 9. Since the other configurations are similar to those of the vibration structure 100L, redundant description is omitted.

Therefore, in a state where the vibration member 1 and the first composite member 20 are integrated, the first part 10a of the first buffer member 10 can be inserted into a space formed between the piezoelectric member 2 and the first part 27 of the first covering member 7 by the third step. The first part 28 of the second covering member 8 can cover a ridge line of the first side surface of the first partial vibration part 11b opposing the first partial frame part 11a at interval, and the first part 29 of the third covering member 9 can cover a ridge line of the second side surface at interval.

Then, in a state where the vibration member 1 and the second composite member 30 are integrated, it is possible to insert the second part 10b of the first buffer member 10 into a space formed between the piezoelectric member 2 and the second part 37 of the first covering member 7 by the fourth step. The second part 38 of the second covering member 8 can cover a ridge line of the first side surface of the first partial vibration part 11b opposing the first partial frame part 11a at interval, and the second part 39 of the third covering member 9 can cover a ridge line of the second side surface at interval.

It is noted that in the exemplary vibration structure 100M, it is not necessary to hold, between the vibration member 1 and the second composite member 30, a spacer for creating the space, and it is possible to reduce the number of constituent members of the vibration structure and simplify the manufacturing process. Similarly to the vibration structure 100L, each buffer member is inserted between at least a part of the flat part of the plate-shaped part of each connection member and the first partial vibration part 11b. As a result, it is possible to more effectively suppress damage due to sagging of the piezoelectric member 2 particularly when a piezoelectric ceramic material is used as the material of the piezoelectric member 2. It is also noted that also in the vibration structure 100M, the number of constituent members can be reduced by omitting the vibration member 1.

Fourteenth Modification of Vibration Structure—

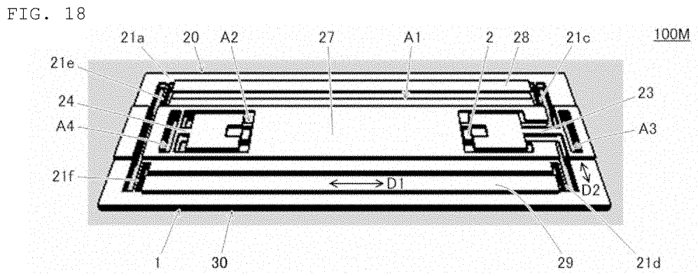

The fourteenth modification of the vibration structure 100, which is a schematic form of the vibration structure according to the present disclosure, will be described with reference to FIG. 20. FIG. 20 is a perspective view of the vibration structure 100N, which is the fourteenth modification of the vibration structure 100. The vibration structure 100N includes constituent members basically similar to those of the vibration structure 100M, and individual constituent members are integrated into three members as the vibration structures 100J and 100K. Also in the vibration structure 100N, the first composite member 20 and the second composite member 30 are in a relationship of being upside down as mentioned earlier. Description of the configuration common to the vibration structure 100M, which is the thirteenth modification, is not repeated.

The vibration structure 100N is configured such that an uneven part (shown as being circled in FIG. 20) is provided at a central part in a long direction of any of upper, middle, and lower vibration plates, and acts as a stopper when applied with impact in the first direction D1 as the long direction. In a case without the stopper, both ends of the central vibration part collide with an outer peripheral frame, and the vibration part is locally bent in the thickness direction near the support part, and a large bending stress is applied to the piezoelectric element fixing part.

However, in this modification, since the central part is provided with the stopper, it is possible to reduce local deformation of a vibrator vibration part can bed, and it is possible to reduce stress applied to the piezoelectric element.

Fifteenth Modification of Vibration Structure—

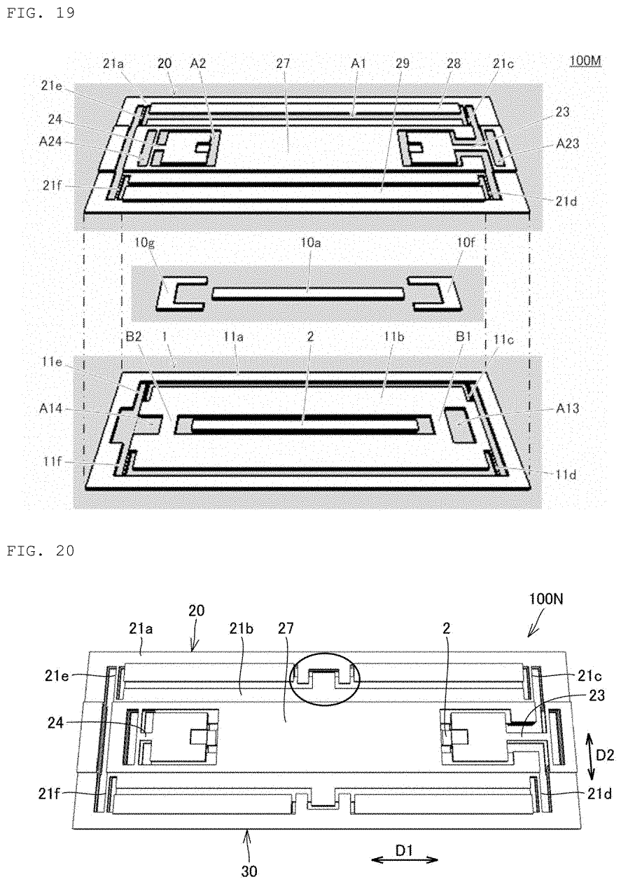

The fifteenth modification of the vibration structure 100, which is a schematic form of the vibration structure according to the present disclosure, will be described with reference to FIG. 21. FIG. 21 is a perspective view of the vibration structure 100P, which is the fifteenth modification of the vibration structure 100. Although some modifications have illustrated examples where the stress relaxation member is T-shaped, the stress relaxation member needs not be T-shaped. In the vibration structure 100P, from the part where the piezoelectric member 2 is fixed, the stress relaxation member is extended not in the first direction D1 as the long direction but in the second direction D2 as the direction orthogonal to this.

Schematic Form of Vibration Device—

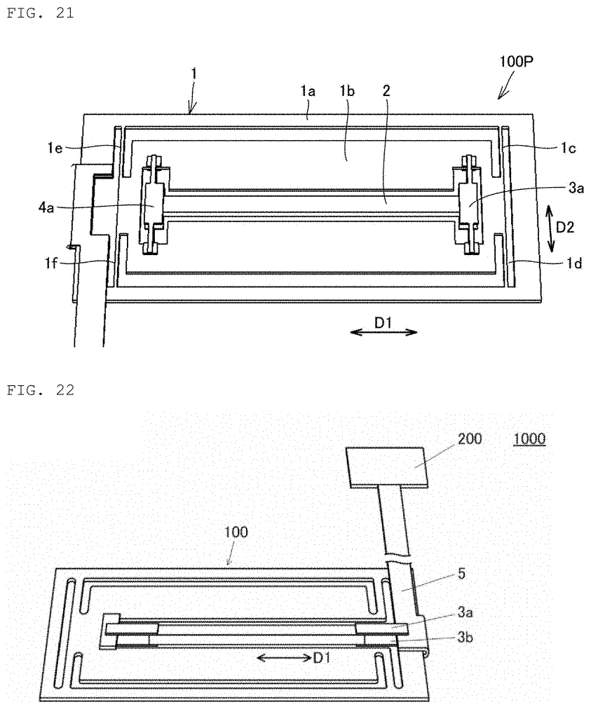

The vibration device 1000 exhibiting a schematic form of a vibration device using the vibration structure according to the exemplary aspects of the present disclosure will be described with reference to FIG. 22. FIG. 22 is a perspective view of the vibration device 1000.

According to an exemplary aspect, the vibration device 1000 includes the vibration structure 100 and the drive circuit 200 that applies voltage to the piezoelectric member 2 included in the vibration structure 100. As mentioned earlier, the piezoelectric member 2 includes the piezoelectric element 2a having a prismatic shape, the first electrode 2b provided on the first main surface of the piezoelectric element 2a, and the second electrode 2c on the second main surface facing back-to-back to the first main surface, and has the first end and the second end (see FIG. 1(B)). When the user operates an operator such as a film switch 300 described later, the drive circuit 200 applies voltage between the respective electrodes of the piezoelectric member 2 to expand and contract the piezoelectric member 2 in the first direction D1. The voltage is applied to the piezoelectric member 2 from the voltage application member 5 described later with the first part 3a and the second part 3b of the first connection member 3 interposed therebetween. However, voltage may be applied by another method.

Application of the voltage is repeatedly performed. That is, the drive circuit 200 applies an alternate-current voltage. The waveform of the applied alternate-current voltage may be any waveform such as a rectangular wave, a triangular wave, or a trapezoidal wave. For example, when a sine wave is applied, unnecessary vibration can be reduced, and eventually, sound generated by this unnecessary vibration can be reduced.

Since the vibration device 1000 according to the exemplary aspect uses the vibration structure 100, failure can be suppressed when receiving impact. Note that the vibration structure to be used is only required to be any vibration structure according to the exemplary aspects, and is not limited to the vibration structure 100.

Schematic Form of Tactile Presentation Device—

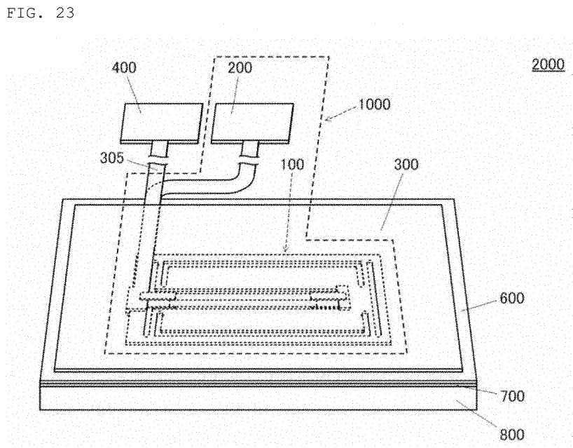

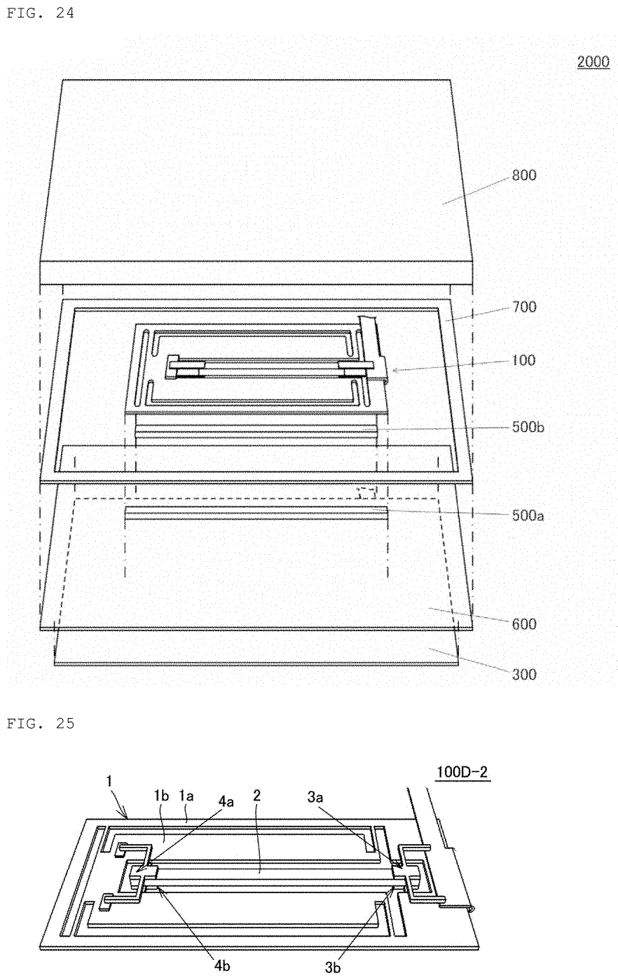

The tactile presentation device 2000 exhibiting a schematic form of a tactile presentation device using the vibration device according to the exemplary aspect of the present disclosure will be described with reference to FIGS. 23 and 24. FIG. 23 is a perspective view of the tactile presentation device 2000. FIG. 24 is an exploded perspective view of the tactile presentation device 2000.

As shown, the tactile presentation device 2000 includes the vibration device 1000 according to the present disclosure and a pressure detection part (e.g., a pressure sensor or detector) that detects pressure on the vibration part 1b. As mentioned earlier, the vibration device 1000 includes the vibration structure 100 and the drive circuit 200. The pressure detection part includes the film switch 300 and a detection circuit 400. The film switch 300 is attached with a conductor line 305, and the conductor line 305 connects the main body of the film switch 300 and the detection circuit 400. The drive circuit 200 applies voltage to the piezoelectric member 2 when the pressure detection part detects pressurization.

In the exemplary aspect, the frame part 1a of the vibration structure 100 is placed on a board 600. The board 600 is attached to a housing 800 with a buffer member 700 interposed therebetween. The vibration structure 100 is sealed in a space formed by the board 600, the buffer member 700, and the housing 800. In the present structure, the vibration part 1b of the vibration structure 100 may be attached to the housing 800. The frame part 1a may be attached to the housing 800 side, and the vibration part 1b may be attached to the board 600 side. A height adjustment spacer may be held between attachment parts of the vibration structure 100 with the board 600 and the housing 800.

The film switch 300 detects pressing by the user. It is noted that the film switch 300 may be of any type as long as being capable of detecting pressing by the user. For example, various methods such as a membrane method, a capacitance method, or a piezoelectric film method can be used.

When the user presses the film switch 300, the detection circuit 400 is configured to detect the pressing by the user. When the detection circuit 400 detects pressing by the user, the drive circuit 200 applies voltage to the piezoelectric member 2 to expand and contract the piezoelectric member 2, and vibrates the vibration part 1b. This allows the user to feel that he/she has “pressed” the film switch 300 by the vibration part 1b vibrating when the user presses the film switch 300.

Since the tactile presentation device 2000 uses the vibration device 1000 according to the present disclosure, it is possible to give the user a tactile sense also when receiving impact. Note that the vibration device to be used is only required to be any device according to the present invention, and is not limited to the vibration device 1000 using the vibration structure 100.

In general, it is noted that the exemplary aspects of the present invention can be applied to a vibration generation device for cutaneous sensory feedback in electronic equipment, for example, or for confirming a key operation or the like by vibration. Examples of the cutaneous sensory feedback include expressing a tactile image when touching a touchscreen display by vibration generated by the vibration structure. However, other cutaneous sensory feedback may be used in alternative aspects.

Note that the touchscreen has been described as an example of a schematic form of the tactile presentation device using the vibration structure according to the present disclosure, but the tactile presentation device is not limited to this configuration.

Examples of the tactile presentation device according to the exemplary aspects include a mobile phone (e.g., a so-called feature phone), a smartphone, a handheld video game console, a tablet personal computer, a laptop personal computer, and a remote controller used for operation of a television set, a touchscreen display used for an automated teller machine and the like, and a touch pad used for a laptop personal computer and the like. In the tactile presentation device 2000, in a case where voltage is applied to the side where the piezoelectric body contracts (negative voltage side in the example illustrated in FIG. 22) as illustrated in FIG. 22, when an alternate-current waveform that reaches a peak in a short time and then gradually decreases in amplitude is repeatedly applied, the vibration part 1b is sharply displaced when the piezoelectric body contracts and is gently displaced when the piezoelectric body gradually returns. The present device having such an operation can also be used as a device for removing and conveying a droplet, powder, and the like.

In general, it is noted that the embodiments disclosed in this description are exemplary, and the invention according to the present disclosure is not limited to the above embodiments and modifications.

### DESCRIPTION OF REFERENCE SYMBOLS

100: Vibration structure
1: Vibration member
1a: Frame part
1b: Vibration part
1c, 1d, 1e, 1f: Support part
2: Piezoelectric member
3: First connection member
3a: First part
3b: Second part
4: Second connection member
4a: First part
4b: Second part
5: Voltage application member
6a: Fixing member
7: First covering member
7a: First part
7b: Second part
8: Second covering member
8a: First part
8b: Second part
9: Third covering member
9a: First part
9b: Second part
10: First buffer member
10a: First part
10b: Second part
A1: First opening
A2: Second opening
A3: Third opening
A4: Fourth opening
D1: First direction
D2: Second direction

1. A vibration structure comprising:
a vibration member including a frame having a first opening, a vibrator disposed inside the first opening and having a second opening, and a support that couples the vibrator to the frame;
a piezoelectric member disposed inside the second opening and having a first end and a second end, and configured to expand and contract in a first direction that connects the first end to the second end when a voltage is applied;
a first connection member that connects the first end of the piezoelectric member to the frame; and
a second connection member that connects the second end of the piezoelectric member to the vibrator,
wherein at least the first connection member is an elastic body.

2. The vibration structure according to claim 1, wherein:
the piezoelectric member has a first main surface and a second main surface,
the first connection member includes a first part and a second part that oppose each other with the first part extending across the piezoelectric member,
a first part of the first connection member connects an end of a first main surface of the piezoelectric member to the frame, and
a second part of the first connection member connects an end of a second main surface of the piezoelectric member to the frame.

3. The vibration structure according to claim 1, wherein the first connection member includes a first plate-shaped part connected to the piezoelectric member, a second plate-shaped part connected to the frame, and a coupling part that couples the first plate-shaped part to the second plate-shaped part along the first direction, with the first connection member having a bent part.

4. The vibration structure according to claim 1, wherein:
the first connection member includes a first plate-shaped part connected to the piezoelectric member, a second plate-shaped part extending along a second direction orthogonal to the first direction and connected to the frame, and a coupling part that couples the first plate-shaped part to the second plate-shaped part,
the frame has a third opening, and
the second plate-shaped part is connected to a periphery of the third opening in the frame so as to be a double-supported beam.

5. The vibration structure according to claim 4, wherein the second plate-shaped part has a bent part on both sides of a connection place with the coupling part.

6. The vibration structure according to claim 1, wherein the vibrator includes a first beam that separates the first opening from the second opening.

7. The vibration structure according to claim 1, wherein the first connection member has a first step disposed between a part connected to the frame and a part connected to the piezoelectric member.

8. The vibration structure according to claim 1, wherein the second connection member is an elastic body.

9. The vibration structure according to claim 8, wherein:
the piezoelectric member has a first main surface and a second main surface,
the second connection member includes a first part and a second part that oppose each other with the first part extending across the piezoelectric member,
a first part of the second connection member connects an end of a first main surface of the piezoelectric member to the vibrator, and
a second part of the second connection member connects an end of a second main surface of the piezoelectric member to the vibrator.

10. The vibration structure according to claim 8, wherein the second connection member includes a first plate-shaped part connected to the piezoelectric member, a second plate-shaped part connected to the vibrator, and a coupling part that couples the first plate-shaped part to the second plate-shaped part along the first direction and that has a bent part.

11. The vibration structure according to claim 8, wherein:
the second connection member includes a first plate-shaped part connected to the piezoelectric member, a second plate-shaped part extending along a second direction orthogonal to the first direction and connected to the frame, and a coupling part that couples the first plate-shaped part to the second plate-shaped part along the first direction,
the vibrator part has a fourth opening, and
the second plate-shaped part is connected to a periphery of the fourth opening in the vibrator so as to be a double-supported beam.

12. The vibration structure according to claim 11, wherein the second plate-shaped part has a bent part on both sides of a connection place with the coupling part.

13. The vibration structure according to claim 8, wherein the vibrator includes a second beam that separates the second opening from the fourth opening.

14. The vibration structure according to claim 9, wherein the second connection member has a second step disposed between a part connected to the vibrator and a part connected to the piezoelectric member.

15. The vibration structure according to claim 1, further comprising a first covering member connected to the vibrator so as to cover at least a part of a surface of the piezoelectric member at an interval from the piezoelectric member.

16. The vibration structure according to claim 15, wherein:
the vibrator has a first main surface and a second main surface, and
the first covering member includes a first part connected to the first main surface of the vibrator and a second part connected to the second main surface of the vibrator.

17. The vibration structure according to claim 15, wherein the first covering member covers at least from a connection place between the piezoelectric member and the first connection member to a connection place between the piezoelectric member and the second connection member.

18. The vibration structure according to claim 15, further comprising:
a first buffer member that is inserted between the piezoelectric member and the first covering member,
wherein:
the piezoelectric member has a first main surface and a second main surface,
the first buffer member includes a first part and a second part,
a first part of the first buffer member is inserted between a first main surface of the piezoelectric member and a first part of the first covering member, and
a second part of the first buffer member is inserted between a second main surface of the piezoelectric member and a second part of the first covering member.

19. The vibration structure according to claim 16, wherein:
the vibrator includes a first side surface and a second side surface that respectively connect the first main surface and the second main surface and that oppose the frame along the first direction,
the vibration structure includes a second covering member that covers, at an interval from the vibrator, at least one of a ridge line between a first side surface and the first main surface of the vibrator and a ridge line between a first side surface and the second main surface of the vibrator, and
a third covering member that covers, at an interval from the vibrator, at least one of a ridge line between a second side surface and the first main surface of the vibrator and a ridge line between a second side surface and the second main surface of the vibrator.

20. The vibration structure according to claim 19, wherein:
the second covering member and the third covering member each include a first part and a second part,
the vibration structure includes the vibration member in which a first partial frame forming the frame, a first partial vibrator forming the vibrator, and a first partial support forming the support are integrally formed, the vibration member having a first partial opening forming the third opening in the frame, and having a second partial opening forming the fourth opening in the vibrator,
a first composite member in which a second partial frame forming the frame, a second partial vibrator forming the vibrator, a second partial support forming the support, a first part of a first connection member having the first step, a first part of the second connection member having the second step, a first part of the first covering member, a first part of the second covering member, and a first part of the third covering member are integrally formed, the first composite member having a third partial opening forming the third opening and a fourth partial opening forming the fourth opening, and
a second composite member in which a third partial frame forming the frame, a third partial vibrator forming the vibrator, a third partial support forming the support, a second part of a first connection member having the first step, a second part of the second connection member having the second step, a second part of the first covering member, a second part of the second covering member, and a second part of the third covering member are integrally formed, the second composite member having a fifth partial opening forming the third opening and a sixth partial opening forming the fourth opening, and
the vibration member is held between the first composite member and the second composite member.

21. The vibration structure according to claim 20, wherein:
the first composite member has a third step disposed between the second partial vibrator and a first part of the first covering member, a first part of the second covering member, and a first part of the third covering member, and a first part of the first buffer member is inserted into a space between the piezoelectric member and the first covering member by the third step, and
the second composite member has a fourth step disposed between the third partial vibrator and a second part of the first covering member, a second part of the second covering member, and a second part of the third covering member, and a second part of the first buffer member is inserted into a space between the piezoelectric member and the second covering member by the fourth step.

22. The vibration structure according to claim 21, wherein:
a width of a first plate-shaped part of the first connection member and the second connection member in the second direction is broader than a width of the piezoelectric member,
the first step is disposed in a first plate-shaped part in a first part and a second part of the first connection member,
the second step is disposed in a first plate-shaped part in a first part and a second part of the second connection member,
a first part of a second buffer member is inserted into a space between the first partial vibrator by the first step and a first part of the first connection member,
a second part of a second buffer member is inserted into a space between the first partial vibrator by the first step and a second part of the first connection member,
a first part of a third buffer member is inserted into a space between the first partial vibrator by the second step and a first part of the second connection member, and
a second part of a third buffer member is inserted into a space between the first partial vibrator by the second step and a second part of the second connection member.

23. A vibration device comprising:
the vibration structure according to claim 1; and
a drive circuit configured to apply the voltage to the piezoelectric member.

24. A tactile presentation device comprising:
the vibration device according to claim 23; and
a pressure detector configured to detect a pressure on the vibrator,
wherein the drive circuit is configured to apply the voltage to the piezoelectric member when the pressure detector detects the pressure.

25. The vibration structure according to claim 3, wherein a second plate-shaped part of the first connection member is connected to the frame along the first direction, and the bent part of the first connection member is disposed along the first direction.

26. The vibration structure according to claim 3, wherein a second plate-shaped part of the first connection member is connected to the frame along the first direction, and the bent part of the first connection member includes a part along a first direction and a part along a direction substantially orthogonal to a first direction.

27. The vibration structure according to claim 8, wherein the second connection member includes a first plate-shaped part connected to the piezoelectric member, a second plate-shaped part connected to the frame, and a coupling part that couples the first plate-shaped part to the second plate-shaped part and that has a bent part.

28. The vibration structure according to claim 27, wherein a second plate-shaped part of the first connection member is connected to the frame along the first direction, and the first connection member has a bent part that is disposed along the first direction.

29. The vibration structure according to claim 27, wherein a second plate-shaped part of the first connection member is connected to the frame along the first direction, and the first connection member has a bent part that includes a part along a first direction and a part along a direction substantially orthogonal to a first direction.
